(19) United States
(12) Patent Application Publication
(10) Pub. No.: US 2025/0059089 A1
(43) Pub. Date: Feb. 20, 2025

(54) METHODS FOR CARBON-CAPTURE WITHIN BIOCHAR

(71) Applicant: Washington State University, Pullman, WA (US)

(72) Inventors: Xianming Shi, Pullman, WA (US); Zhipeng Li, Pullman, WA (US)

(21) Appl. No.: 18/815,916

(22) Filed: Aug. 27, 2024

Related U.S. Application Data
(63) Continuation-in-part of application No. PCT/US2024/018024, filed on Mar. 1, 2024.
(60) Provisional application No. 63/619,227, filed on Jan. 9, 2024.
(60) Provisional application No. 63/488,440, filed on Mar. 3, 2023.

(51) Int. Cl. C04B 14/28; C04B 28/04

(52) U.S. Cl. CPC C04B 14/28; C04B 28/04

(57) ABSTRACT

Methods for carbon-capture within a biochar are provided. The method includes mixing a biochar with an alkaline solution to form an intermediate mixture and exposing the intermediate mixture to a CO₂ source so as to precipitate calcium carbonate onto and into the biochar to form a CO₂-weathered biochar. In some cases, the method also includes injecting CO₂ into alkaline wastewater to sequester/store CO₂ which can then serve as mixing water for producing cementitious composites. This method may be used to upcycle three waste streams, and treated CO₂-weathered biochar preserves compressive strength of resultant concrete when substituted for a portion of the pre-cure cement and aggregate components. Further, treated CO₂-weathered recycled aggregate preserves mechanical strength of resultant concrete when substituted for a portion of aggregate.

### CROSS REFERENCE TO RELATED APPLICATIONS

This application is a continuation-in-part of International Application PCT/US2024/018024 filed Mar. 1, 2024 which claims the benefit of U.S. Provisional Patent Applications 63/488,440 filed on Mar. 3, 2023 and 63/619,227 filed on Jan. 9, 2024, and incorporates said applications by reference into this document as if fully set out at this point.

### FEDERALLY SPONSORED RESEARCH

This invention was made with government support under grant number 69A3551947137 awarded by the United States Department of Transportation. The government has certain rights in the invention.

### TECHNICAL FIELD

This disclosure relates to the use of waste alkaline solutions to treat biochar and optionally recycled aggregate for increased carbon capture within cementitious composites. Additionally, the disclosure involves carbonating an alkaline solution to serve as mixing water for further carbon capture within cementitious composites.

### BACKGROUND

Cementitious concrete construction continues to be an essential component of the built environment, but existing methods and formulations are recognized to contribute a significant portion of anthropologic CO₂ emissions and thus threaten the sustainability of human society.

Produced from pyrolysis of various feedstocks (e.g., biomass), biochar (B) has demonstrated great potential in stabilizing and storing CO₂. Biochar has been increasingly added to concrete applications as a supplementary cementitious material (SCM). Beneficial use of biochar in cementitious materials has generally been limited to no more than 5% by weight of cement, i.e., far from achieving carbon neutrality. Beyond this proportion, the reduction in mechanical strength of cementitious materials is considerable.

Despite recent advances towards net carbon-neutral/negative concrete enabled by biochar, there are technical barriers including: weak strength of biochar, poor interfacial transition zone (ITZ) between biochar and cementitious matrix, and less-than-specified performance of biochar-amended cementitious composites.

Accordingly, a need exists to accommodate diverse types of biochar (produced from various feedstocks) to produce cementitious composites with varying requirements in mechanical properties and durability performance, for a variety of building and construction applications. This disclosure addresses such a need.

### SUMMARY

This disclosure provides low-cost and facile approaches for carbon capture within a biochar to produce cementitious composites with greatly reduced carbon footprint, including carbon-neutral and carbon-negative concrete as well as other cementitious composites (e.g., strain-hardening engineered cementitious composite, cellular concrete, shotcrete, 3D printable concrete, timber/concrete composite, and cement stabilized soil). Additionally, this disclosure incorporates similar carbonation strategies of recycled aggregate and alkaline solution to further sequester/store CO₂ and benefit the carbon-neutral/negative concrete.

An aspect of the disclosure provides a CO₂-weathered biochar, comprising a biochar; and calcium carbonate particles precipitated on or within the biochar or on surfaces that extend into the biochar, wherein a size of the calcium carbonate particles ranges from 1-5000 nanometers.

Another aspect of the disclosure provides a cementitious composite, comprising a biochar; calcium carbonate particles precipitated on or within the biochar, wherein a size of the calcium carbonate particles ranges from 1-5000 nanometers; cement; and an aqueous solution. In some embodiments, the biochar comprises particles having a size of 150 micrometers or less. In some embodiments, the CO₂-weathered biochar replaces 1% to 80% by mass of a dry pre-mix total quantity of the cement in the cementitious composite. In some embodiments, the CO₂-weathered biochar replaces 1% to 40% by mass of a dry pre-mix total quantity of the cement in the cementitious composite. In some embodiments, the biochar comprises particles having a size of 1-150 micrometers. In some embodiments, the cementitious composite further comprises aggregates and wherein the CO₂-weathered biochar replaces 1% to 20% by mass of a dry pre-mix total quantity of the aggregates in the cementitious composite. In some embodiments, the cementitious composite does not comprise any aggregates. In some embodiments, the cementitious composite comprises recycled aggregate. In some embodiments, the recycled aggregate is carbonated. In some embodiments, a compressive strength of the cementitious composite is increased as compared to a corresponding cementitious composite without the CO₂-weathered biochar. In some embodiments, the cementitious composite is selected from the group consisting of concrete, paste, grout, mortar, and cement stabilized soil. In some embodiments, the biochar is a surface-modified biochar. In some embodiments, the cementitious composite further comprises a fiber material.

Another aspect of the disclosure provides a method for carbon capture within a biochar, comprising mixing a biochar with an alkaline solution to form an intermediate mixture; and exposing the intermediate mixture to a CO₂ source so as to precipitate calcium carbonate onto and into the biochar to form a CO₂-weathered biochar. In some embodiments, CO₂ is also injected into the alkaline solution to sequester/store CO_{2,} and then this carbonated alkaline solution is used for mixing cementitious materials, when its pH of solution reaches 7 or higher. In some embodiments, the method further comprises iterating the mixing and exposing steps to treat the intermediate mixture with additional quantities of alkaline solution. In some embodiments, the alkaline solution comprises a supernatant of concrete washout water. In some embodiments, a volume ratio of the alkaline solution and the biochar is from 3:1 to 1:1. In some embodiments, the CO₂ source is a gaseous CO₂ and/or carbonic acid. In some embodiments, carbonation includes air exposure and/or gaseous CO₂ injection into the solution.

Another aspect of the disclosure provides a CO₂-weathered biochar and/or recycled aggregate and/or carbonated alkaline solution prepared by the methods as described herein.

Another aspect of the disclosure provides a method for carbon capture within a cementitious composite, comprising mixing a biochar and/or recycled aggregate with an alkaline solution to form an intermediate mixture; exposing the intermediate mixture to a CO₂ source so as to precipitate calcium carbonate onto and into the biochar to form a CO₂-weathered biochar and/or recycled aggregate; and mixing the CO₂-weathered biochar and/or recycled aggregate with a cement and water to form the cementitious composite. Carbonation of alkaline solution may comprise injecting gaseous CO₂ into alkaline solution until its pH reaches 7 or higher and then using it as mixing water for producing cementitious composites. In some embodiments, the biochar comprises particles having a size of 150 micrometers or less. In some embodiments, the CO₂-weathered biochar replaces 1% to 80% by mass of a dry pre-mix total quantity of the cement in the cementitious composite. In some embodiments, the CO₂-weathered biochar replaces 1% to 40% by mass of a dry pre-mix total quantity of the cement in the cementitious composite. In some embodiments, the biochar comprises particles having a size larger than 150 micrometers. In some embodiments, the cementitious composite further comprises aggregates and the CO₂-weathered biochar replaces 1% to 20% by mass of a dry pre-mix total quantity of the aggregates in the cementitious composite. In some embodiments, the cementitious composite does not comprise any aggregates. In some embodiments, the biochar and/or the water is carbonated. In some embodiments, the recycled aggregate (e.g., recycled concrete aggregate) is mixed with pure water rather than alkaline solution to sequester/store CO₂. In some embodiments, carbonation includes air exposure and/or gaseous CO₂ injection into the solution. In some embodiments, carbonated recycled aggregate serves to partially replace fine aggregate when its size ranges from 150 micrometers to 9.5 millimeters, and partially replace coarse aggregate when its size ranges is greater than 9.5 millimeters, and serve as fillers and/or reactor for cementitious composites when its size is less than 150 micrometers.

In some embodiments, a compressive strength of the cementitious composite is increased as compared to a corresponding cementitious composite without the CO₂-weathered biochar. In some embodiments, the cementitious composite is selected from the group consisting of concrete, paste, grout, mortar, and cement stabilized soil. In some embodiments, the method further comprises pretreating the biochar with a solution containing nanomaterials before the biochar is mixed with the alkaline solution. In some embodiments, the method further comprises pretreating the biochar with one or more oxidizing agents before the biochar is mixed with the alkaline solution. In some embodiments, the biochar is a surface-modified biochar. In some embodiments, the cementitious composite further comprises a fiber material.

Another aspect of the disclosure provides a cementitious composite prepared by the methods as described herein.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE DRAWINGS

FIG. 1 depicts a process of synergistic CO₂ capture by concrete washout water and biochar.

FIG. 2 shows 7- and 28-day compressive strengths of treated biochar paste specimens.

FIG. 3A shows thermogravimetric analysis/derivative thermogravimetric (TGA/DTG) for original and treated biochar.

FIG. 3B shows Fourier transform infrared spectroscopy (FTIR) results of the original and treated biochar.

FIG. 3C shows TGA/DTG of Portland limestone cement (PLC), PLC+30 wt. % biochar (B), and PLC+30 wt. % CO₂-weathered biochar (CWB) pastes.

FIG. 3D shows representative microstructure of PLC-biochar paste. The inset shows calcium carbonate precipitated on the surface of CWB.

FIG. 4 is a flow chart for example embodiment of processing CWB for use as an SCM.

FIG. 5 shows concrete compressive strengths for one-time vs. three-times treated biochar.

FIG. 6 shows concrete compressive strengths for different biochar dosages at 15% by weight replacement.

FIG. 7 shows concrete compressive strengths for different biochar dosages at 20% by weight replacement.

FIG. 8 shows compressive strength of cement replacement by 5% biochar by weight.

FIG. 9 shows compressive strength of cement replacement by 10% biochar by weight.

FIG. 10 shows 28-day compressive strength of selected PLC paste with various chemically treated biochars.

FIG. 11 shows FTIR patterns of selected biochar samples.

FIG. 12 shows the compressive strength and thermal conductivity of designed cellular concrete.

FIG. 13A shows the compressive strength of biochar-modified specimens.

FIG. 13B shows the total shrinkage of ECC specimens for 50 days.

FIG. 14 shows compressive strength of ECC samples containing biochar.

FIG. 15 shows the total shrinkage of ECC samples containing biochar.

FIG. 16A-D shows 7- day and 28-day compressive strength of cement paste specimens with ground (A) Oregon biochar, (B) wheat straw biochar, (C) OurCarbon biochar, and (D) Heartland biochar.

FIG. 17 shows reduction of compressive strength with respect to the replacement level of ground biochar.

FIG. 18A-D shows compressive strength of cement mortar specimens with (A) Oregon biochar, (B) wheat straw biochar, (C) OurCarbon biochar, and (D) Heartland biochar after various cycles of CO2 weathering.

FIG. 19 shows quantification of CO2 weathered products and calcite in OurCarbon biochar after CO2 weathering.

FIG. 20 shows ultimate compressive strength of concrete with ground biomass-mased biochar and CO2 weathered biosolid-based biochar.

FIG. 21A-B shows (A) water absorption and (B) water absorption rates of concrete with ground biomass-mased biochar and CO2 weathered biosolid-based biochar.

### DETAILED DESCRIPTION

In the description herein, a word appearing in the singular encompasses its plural counterpart, and a word appearing in the plural encompasses its singular counterpart, unless implicitly or explicitly understood or stated otherwise. Furthermore, it is understood that for any given component or embodiment, any of the possible candidates or alternatives listed for that component may generally be used individually or in combination with one another, unless implicitly or explicitly understood or stated otherwise. Moreover, the figures are not necessarily drawn to scale, wherein some of the elements may be drawn merely for clarity. Also, reference numerals may be repeated among the various figures to show corresponding or analogous elements. Additionally, any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Various embodiments of carbon capture are described herein. In the following description, specific details of systems, components, and operations are included to provide a thorough understanding of certain embodiments of the disclosed technology. A person skilled in the relevant art will also understand that the technology may have additional embodiments. The technology may also be practiced without several of the details of the embodiments described below.

As disclosed herein, “biochar” refers to a product obtained by the thermal decomposition or pyrolysis of biomass material (e.g., carbohydrates, cellulose, protein-containing and/or fat-containing materials, such as wood, agricultural residues, fertilizers, etc.). The extent to which feedstock materials will burn depends upon the equivalent ratio of the number of moles of oxygen fed to the reactor in comparison with the equivalent number of moles of carbon in the product being subjected to the heating process. Thus, if the equivalent ratio is zero, ie. there is no oxygen in the reactor, the process is often termed a “pyrolysis” process. If the equivalent ratio is less than about 0.15, such processes are generally termed “pyrolytic gasification” or “flaming pyrolytic gasification”; whereas, if the equivalent ratio is about 0.15 to about 0.3, such processes are typically known as “gasification” in the art.

Cement refers to any inorganic cementitious substance wherein the substance is capable of condensing with water and hardening due to the interaction of the water with the components of the substance to serve as a binder for the material.

As utilized herein, “concrete” refers to any type of building material that contains aggregates embedded in a matrix (cement or binder) that fills the spaces between the aggregates and binds them together.

Concrete generally is a mixture of cement, water, and aggregate material. Portland cement, for example, is made by heating a mixture of limestone and clay containing oxides of calcium, aluminum, silicon, and other metals and then pulverizing the material. Aggregate particles are usually sand and gravel and/or crushed stone. When cement is mixed with water, a chemical reaction called hydration occurs, which produces glue that binds the aggregates together to make concrete. It is to be noted that after concrete is poured at a construction site, the chutes of concrete trucks and hoppers of concrete pump trucks must be washed out to remove the remaining concrete before it hardens, and this washed-out material is a slurry including supernatant deemed as concrete washout water and precipitation deemed as high water-to-binder ratio paste.

Supernatant refers to the liquid lying above a solid residue after crystallization, precipitation, centrifugation, or other processes.

An alkaline solution refers to a solution having a pH greater than 7, e.g. a pH at least larger than 7, e.g. at least 7.01, 8, 9, 10, 11, 12, or greater. The solution may be an aqueous alkaline solution. In some embodiments, the alkaline solution comprises alkaline wastewater or solutions from food processing factories, concrete mixing factories, concrete washout water, paper milling factories, and alkaline water generated from other industry processes. The alkaline solution may include supernatant and/or precipitate from such sources.

A recycled aggregate refers to a solid material with various size distribution. In some embodiments, the recycled aggregate comprises recycled concrete aggregate, demolished bricks, recycled low-quality sand and rocks, gravel, sand, slag, topsoil, ballast, and geosynthetic aggregates. In some embodiments, recycled aggregate, e.g. carbonated recycled aggregate, serves to partially replace fine aggregate when its size ranges from 150 micrometers to 9.5 millimeters, and partially replace coarse aggregate when its size is greater than 9.5 millimeters, and serve as fillers and/or reactor for cementitious composites when its size is less than 150 micrometers. Specific Description

Embodiments of the disclosure provide for the treatment of biochar with an alkaline solution to capture and sequester CO₂, such as airborne or industrial CO₂, wherein precipitated calcium carbonate into/onto the biochar provides for a deemed CO₂-weathered biochar. A resultant carbon-negative cement paste incorporating the CO₂-weathered biochar beneficially achieves increased compressive strengths, e.g. of up to 30 MPa or more.

The size of carbonate particles precipitated into the pores of the biochar or onto the biochar surface or on surfaces that extend into the biochar may be controlled to between 1 nanometer and 5,000 nanometers. This can be achieved by controlling the concentrations of the reactants (e.g. CO₂, Ca cations, pH, etc.) and/or the duration of exposure or the number of wet/dry cycles. This size range ensures the reactivity of the carbonated biochar and facilitates its chemical bonding with a cementitious matrix, which translates to better mechanical properties and durability of the biochar-amended cementitious composite (e.g. paste, mortar, grout, concrete, or cement stabilized soil).

Using biochar of fine size (e.g. 150 micrometers or less, e.g. 1-150 micrometers) to replace cement in the mass range of 1% to 40% and/or biochar of coarse size (e.g. greater than 150 micrometers) to replace fine aggregate in the mass range of 1% to 20%, methods disclosed herein can produce cementitious composites (e.g. paste, grout, mortar, concrete, or cement stabilized soil) that have zero or negative CO₂ emission over their service life. This can accommodate diverse types of biochar (produced from various feedstocks) to produce cementitious composites with varying requirements in mechanical properties and durability performance, for a variety of building and construction applications, and the performance enhancements can be achieved by physical grinding, surface modification, nano-modification, and CO₂ curing, either individually or in combination. For engineering applications with lower strength requirements, disclosed methods can further increase the cement replacement by fine biochar up to 80% and increase the fine aggregate replacement by coarse biochar to 100%.

Exemplary biochar feedstocks include, but are not limited to, biomass from forestry residues (e.g. wood biomass), municipal biosolids, materials of animal origin (e.g. manure), waste from the paper and cellulose industry, recycled plastics or rubber, forestry and commodity crop residues, energy crops, bioprocessing waste, or biomass from other agricultural sources such as coconut shells, rice husks, and sugarcane bagasse, and other solid organic wastes such as sewage sludge, etc.

The quality of biochar may depend on the pyrolysis condition (i.e., pyrolysis temperature, heating rate, pressure, residence time) and on the biomass feedstock. Generally, biochar is a stable carbon-rich material whose carbon content ranges from about 50% for high ash feedstocks and low pyrolysis temperatures (ca. 350° C.) at to as high as 93% for low ash feedstocks pyrolyzed at high temperatures (ca. 800° C.). Properties of biochar such as surface area, pore structure, particle size, morphology, and pH value may be determined by pyrolysis condition and milling parameters. These properties are correlated with each other and can further influence the properties of biochar that have direct influences on concrete durability, including water retention capacity and cation exchange capacity.

In some embodiments, the pyrolysis temperature used to prepare the biochar ranges from about 250-1300° C., e.g. 300-800° C., with a heating rate of about 0.1-1000° C./s and a reaction time of about 0.5-1000 seconds. Preferably, the biochar has a surface area of about 100 m²/g to about 600 m²/g. The biochar may have a bulk density of about 0.01 to about 0.90 Mg/m³, using a method in accordance with ASTM D1762-84 (105C). The biochar may have pores of various sizes, e.g. from about 1-100 μm in size. The biochar particles may have a size ranging from about 10 nm to 1000 μm or more. In some embodiments, the H/Corg ratio range for biochars is typically 0.2 to 0.7 indicating a high degree of transformation with some deviation from a full graphite structure.

Biochar with a smaller particle size conveys higher surface area, which can provide additional surface area for nucleation and growth of cement hydrates. Biochar can function as a “filler” to increase the packing density of cement composites, and fine biochar particles act as seeds to facilitate cement hydration and improve strength development. On the other hand, biochar-modified concrete requires more water-reducing admixture to counteract the water absorption of biochar and maintain a consistent workability of the fresh mixture. As colloids, biochar nanoparticles have higher surface area per unit volume, relative to biochar microparticles. The associated stronger Van der Waals and electrostatic forces can cause them to re-agglomerate, which is known to be deleterious to cementitious composites. Interestingly, biochar nanoparticles show less effect on the workability of cement mortar, likely due to the higher availability of free water to act as a lubricant that reduces interparticle friction.

The roughness in the appearance of biochar can promote the adhesion between biochar and cement paste, which helps avoid early fracture of cement composites. With the addition of biochar in cement mortar, the flexural strength and fracture energy increased by up to 10% and 83%, respectively. Angular-shaped biochar particles tend to reduce the flowability of cement mixtures by restraining the movement of cement paste but have the potential of bridging aggregate and cement matrix over the interfacial transition zone (ITZ). Extensive milling and grinding promote fine-grained angular-shaped biochar particles.

For pore structure and density of biochar, increasing the pyrolysis temperature leads to more release of volatile matter and pore formation, yielding biochar with a higher porosity and a lower density. The density of biochar is only about 30% of OPC making it a good candidate for producing lightweight concrete structures and thermal insulation foamed concrete. The water retention capacity of biochar, which is highly related to its pore structure, offers internal curing to biochar-modified concrete. Biochar has been reported to promote formation of calcium-silica-hydrates (C—S—H) and calcium hydroxide (CH). In addition, pozzolanic reactivity has been reported for biochars made from feedstocks having high silica contents (e.g., rice husks and pulp/paper mill wastes).

In some embodiments, the biochar used herein has a mineral content of about 10-80 wt. %. Biochar with sufficient mineral content (e.g., at least 10%) can induce nano-carbonate formation by CO₂ weathering of biochar. Without being bound by theory, exemplary working mechanisms of the biochar as described herein are as follows.

1) Biochar (due to its high porosity) provides an “internal curing” mechanism, continually supplying moisture inside the hardened concrete, which facilitates the formation of additional calcium-silicate-hydrate (C—S—H) gel and improves the degree of hydration of cement particles.

2) Biochar (with fine particles of sizes similar to cement particles) provides additional surface area for nucleation and growth of cement hydrates, i.e., potential for higher rate of strength gain.

3) Some biochar works as supplementary cementitious material (SCM), because of the presence of high level of amorphous silicate phases (i.e., pozzolanic reactivity) in the biochar.

4) The presence of some biochar in concrete can densify the microstructure of hardened concrete through the filler effect (i.e., improving the packing density of the mixture), thus improving the strength and durability of the concrete.

Usually, biochar will also decrease the density and the “dead load” of the cementitious material itself. Biochar can also mitigate the internal stress buildup in the hardened concrete through the built-in porosity of the biochar and thus mitigate the damage by freeze/thaw cycling, oxychloride formation, sulfate attack, alkali-aggregate reactions, and various other deterioration mechanisms.

The biochar concrete described herein demonstrates improved resistance to shrinkage cracking (up to 15%), and typically 20% to 50% better resistance to freeze/thaw and salt scaling and 20% to 40% better resistance to external sulfate attack. Two other working mechanisms are as follows.

1) Biochar serves as lightweight aggregate to continually supply moisture from inside the hardened concrete matrix, thus reducing the risk of shrinkage cracking.

2) Biochar can improve the flexural and tensile performance of concrete by “reinforcing effect” (i.e., bridging/deflecting the cracks) and adsorption of fracture energy.

As described herein, the biochar may be further modified to enhance performance. The types of biochar modification include, but are not limited to: physical milling, chemical weathering/surface modification/grafting, CO₂ activation, and nano-modification.

Single or multiple chemical agents may be used to pretreat biochar, such as oxidizing agents (e.g. strong acids, peroxide, potassium permanganate, or chlorate), or a high-energy beam (e.g., laser) to generate graphene-oxide-like chemistry on the surface of the biochar. The dosage of modified fine biochar may range from 0-40 wt. % or more of total cement and the dosage of modified coarse biochar may range from 0-20 wt. % or more of total fine aggregate. When mixing the biochar with the alkaline solution, the temperature may range from ambient temperature (about 25° C.) to 80° C., and the pressure may range from 1 atm to 5 atm. The expected 28-day compressive strength may range from 7250 psi to 10500 psi to meet various application requirements.

Surface modification of the biochar includes chemical treatments such as oxidation and functional group grafting. For example, hydrogen peroxide (H₂O₂) or potassium permanganate (KMnO₄) may be used to oxidize the biochar, graft —COOH or —OH groups, and thereby introduce graphene-oxide-like chemistry onto the surface of the biochar. Further, sodium hydroxide (NaOH) may be used to pretreat the biochar to graft more —OH functional groups.

In further embodiments, single or multiple type(s) of nanomaterial may be used to fill into or coat onto either the fine or coarse biochar. The type of nanomaterials used may include those featuring nanoplatelets such as: nanoclays (e.g., montmorillonite and halloysite) and graphene-derived materials (graphene, reduced graphene oxide, graphene oxide, surface-functionalized graphene). Additional nanomaterials may include nanoparticles or nanofibers: nanosilica, C—S—H (calcium silicate hydrate), nano-hydraulic cement, carbon nanotubes, carbon nanofibers, nanocellulose (cellulose nanocrystal, cellulose nanofibers, bacterial nanocellulose), chitin, nano-carbonate, nano-iron oxide, nano-boron, nano-alumina, and nano-titania. These materials could work synergistically with the nanoplatelets mentioned above. The dosage of nanomaterial may range from 0.05% to 2.0%, preferably 0.08% to 1.5%, by total weight of the biochar. The nanomaterial may first be dispersed as fully as possible in water or aqueous emulsion, either by mechanical shear force or by ultrasonic force, before being mixed with the biochar.

As described herein, the biochar is mixed with an alkaline solution to form an intermediate mixture and the intermediate mixture is exposed to a CO₂ source so as to precipitate calcium carbonate onto and into the biochar to form a CO₂-weathered biochar. In some embodiments, the method further comprises iterating the mixing and exposing steps to treat the intermediate mixture with additional quantities of alkaline solution, e.g. the steps may be repeated an additional 1-50 times. In some embodiments, a volume ratio of the alkaline solution and the biochar is from 10:1 to 1:1, e.g. 3:1 to 1:1. In some embodiments, the CO₂ source is a gaseous CO₂ (e.g. from the air) and/or carbonic acid.

Further embodiments provide a CO₂-weathered biochar prepared by the methods as described herein.

Further embodiments provide a method for carbon capture within a cementitious composite, comprising the mixing and exposing steps described above and further mixing the CO₂-weathered biochar with a cement and water to form the cementitious composite.

A cement is a substance used for construction that sets, hardens, and adheres to other materials to bind them together. For example, cement may be used to bind aggregate (e.g. sand and gravel) together to form concrete. Cements used in construction are usually inorganic, often lime or calcium silicate based. The methods of the present disclosure are compatible with any type of hydraulic or non-hydraulic cement. Cements may comprise a mixture of silicates and oxides. Suitable cements include, but are not limited to, Portland cement, Blended Portland cement, pozzolan-lime cement, white cement, oil well cement, calcium aluminate cement, calcium sulfoamluminate cement, polymer modified/impregnated cement, expansive cement, and cements for ultra high performance concrete, etc. To further reduce the carbon footprint of cementitious composites, methods described herein may also utilize unconventional cements such as portland limestone cement (e.g. with 15 wt. % ground limestone), supplementary cementitious materials (SCMs, e.g., fly ash, ground granulated blast furnace slag, silica fume, calcined clays, and natural pozzolans), calcium aluminate cement, magnesium phosphate cement, alkali-activated ash or slag, and geopolymer binders in place of cement.

In some embodiments, the CO₂-weathered biochar having a size of 150 micrometers or less replaces 1% to 80% (e.g. 1-40%) by mass of a dry pre-mix total quantity of the cement in the cementitious composite. In some embodiments, the cementitious composite further comprises aggregates and the CO₂-weathered biochar having a size larger than 125 micrometers replaces 1% to 20% by mass of a dry pre-mix total quantity of the aggregates in the cementitious composite.

In some embodiments, the CO₂-weathered recycled aggregate replaces 1% to 100% (e.g. 10-90%) by mass of natural aggregate used in the cementitious composite, with size match.

The composites described herein may or may not contain aggregates. In some embodiments, the only aggregate present is a biochar of coarse size as described herein. Concrete aggregates are an inert filler in a concrete mixture. Exemplary concrete aggregates include, but are not limited to, recycled concrete aggregate, demolished bricks, gravel, sand, recycled low-quality sand and rocks, slag, topsoil, ballast, and geosynthetic aggregates. Concrete aggregates may comprise 30-90 wt % of the concrete mixture.

In some embodiments, a compressive strength of the cementitious composite is increased as compared to a corresponding cementitious composite without the CO₂-weathered biochar. In some embodiments, the cementitious composite is selected from the group consisting of concrete, paste, grout, mortar, and cement stabilized soil. Aspects of the disclosure provide a cementitious composite prepared by a method as described herein.

Cement starts to set when mixed with water, which causes a series of hydration chemical reactions. Water generally comprises 10-20 wt % of the mixture. The constituents slowly hydrate and the mineral hydrates solidify and harden. The interlocking of the hydrates gives cement its strength. Hydraulic cement does not set by drying out. Instead, proper curing requires maintaining the appropriate moisture content necessary for the hydration reactions during the setting and the hardening processes. If hydraulic cements dry out during the curing phase, the resulting product can be insufficiently hydrated and significantly weakened. Suitable temperatures for curing generally range from 5° C. to 30° C. During the curing process, the concrete should be protected against water evaporation due to direct insolation, elevated temperature, low relative humidity, and wind.

Cement composites or mixtures as described herein may further comprise one or more additional materials such as concrete additives. For example, the mixture may include siliceous or calcareous fly ash, slag cement, and/or silica fume. Such additives may be included at a dosage of 0-10% by the total weight of solid constituents.

In some embodiments, the cementitious composite further comprises a fiber material. In some embodiments, recycled fibers (e.g. from textiles, carpet, composite, masks, etc.) are included at 0.5-2 vol. % (if a few mm in diameter) or at 0.1 to 0.3 vol. % (if a few microns in diameter) to improve cohesiveness (e.g. in fresh shotcrete) and provide toughness (e.g. in hardened shotcrete). The shotcrete may be 3D printed. Nanomaterials (e.g. nanoclay, nanosilica, graphene oxide, etc.) can be used in the dosage from 0.1-3.0% by weight of biochar to guarantee the strength and to achieve less rebound and better adhesion. The slump of the shotcrete may range from 7 to 12 cm.

In some embodiments, a combination of (Sodium alpha-olefin sulfonate (AOS)+Alcohol ethoxylate (AEO)+Na₃PO₄):0.1-5% by weight of cement is incorporated to serve as foaming and foam-stabilizing agents.

In some embodiments, the composite comprises cement:biochar (both fine and coarse):AOS:AEO:Na₃PO₄=30:70:1:2:0.75. The dosage of cement may vary from 20-60 wt. %, and biochar:40˜80 wt. %. In the combination of fine and coarse biochar, the content of coarse biochar may be above 50%, to serve as built-in porosity (bubbles).

The amounts of coarse and fine biochar, nanomaterials, and other raw materials can be adjusted to meet the requirements of different types of masonry mortar such as: Type N required 750 psi, Type O required 350 psi, Type S required 1800 psi, usually between 2300˜3000 psi, Type M required 2500 psi, and Type K required 75 psi.

In some embodiments, the biochar, water, or concrete aggregate is carbonated before being used in a method as described herein. Carbonation includes but is not limited to nature weathering carbonation in the atmosphere, or accelerated carbonation with designed temperatures and CO₂ concentration. Recycled concrete aggregate (RCA; recycled concrete used as an aggregate) or concrete demolition waste fines may be carbonated and used along with biochar. The dosage of biochar may range from 0-30 wt. % of cement, the dosage of RCA may range from 0-60 wt. % of total aggregate, and the content of nano-/micro-carbonate may range from 0-10 wt. % of biochar.

In some embodiments, fine biochar is used to replace cement up to 30% by weight of cement and achieve a carbon-negative, strain-hardening engineered cementitious composite (ECC) with a 28-day compressive strength of more than 15080 psi (104 MPa) and significantly reduced drying shrinkage. The tensile strength, first-cracking strength, and strain capacity of such biochar ECC can reach 1160 psi (8 MPa), 870 psi (6 MPa) and 4.8%, respectively.

As shown in the Examples, the synergistic carbon-capture strategy, i.e., using alkaline waste solutions and biochar together to achieve a carbon-negative concrete has been demonstrated and laboratory tested to include mechanical strength and microscopic investigation. This approach enables biochar to capture 22.85 wt. % air-borne CO₂ or more, which precipitates calcium carbonate into/onto the biochar. A carbon-negative cement paste incorporating the CO₂-weathered biochar (CWB) and Portland limestone cement at 30:70 mass ratio achieves 7-day and 28-day compressive strengths of 22.1 MPa and 27.6 MPa, respectively. A microscopic investigation reveals the mechanisms underlying the enhanced strengths of such biochar-amended concrete.

The pore structure and hydration products of biochar concrete may be controlled through appropriate timing and duration of CO₂ curing, while increasing its sequestration of CO₂. The CO₂ curing includes, but is not limited to, a set of combinations of temperature, moisture, lasting time, and CO₂ concentration. The temperature of CO₂ curing may range from ambient temperature (e.g. about 25° C.) to 60° C., moisture of CO₂ curing may range from about 20% to 90%, the curing lasting time may range from about 30 min to 12 hours, pressure of CO₂ curing may range from about 1 to 5 atm, and the CO₂ concentration may range from about 1% to 60%.

The present disclosure provides durable, carbon-smart alternatives for the building and construction sector that is attracting more and more attention for its carbon footprint. The value-added application of biochar as a partial replacement of cement and/or fine aggregate can be a win-win strategy of reducing CO₂ emission and enhancing carbon sequestration. The conversion of biomass to biochar can reduce about 0.4-1.2 tons of CO₂ emission for one ton of dry feedstock.

As an example, a biochar concrete obtained by replacing 10% of the cement and 10% of the sand can correspond to 150% of the CO₂ eq emitted in concrete fabrication. The net climate offset, however, is much larger in many instances because it depends on the alternative fate of the original waste biomass. The offset also varies with the timeline considered due to different atmospheric residence times of the greenhouse gases and aerosols (GHG/A) produced during biomass conversion and decomposition.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. Thus, the invention in its broader aspects is therefore not limited to the specific details, representative apparatus and methods and illustrative examples shown and described. Accordingly, departures may be made from such details without departing from the scope or spirit of applicant's general inventive concept.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. at which the cell reaction takes place

The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

This study used biochar (e.g., the OurCarbon™) from pyrolysis of organic waste (BioforceTech, South San Francisco, CA). TABLE 1 provides its chemical composition.

TABLE 1
Component (wt. %)

| Elemental Ash Content (~66 wt/%) contains mainly inorganic matters | | | | | | | | | | | |
|---|---|---|---|---|---|---|---|---|---|---|---|
| SiO₂ | Al₂O₃ | TiO₂ | Fe₂O₃ | CaO | MgO | Na₂O | K₂O | P₂O₅ | SO₃ | Cl | Carbon |
| 27.43 | 12.19 | 1.68 | 14.08 | 14.10 | 3.17 | 1.70 | 1.04 | 1613 | 7.77 | 0.01 | (32.86%) |

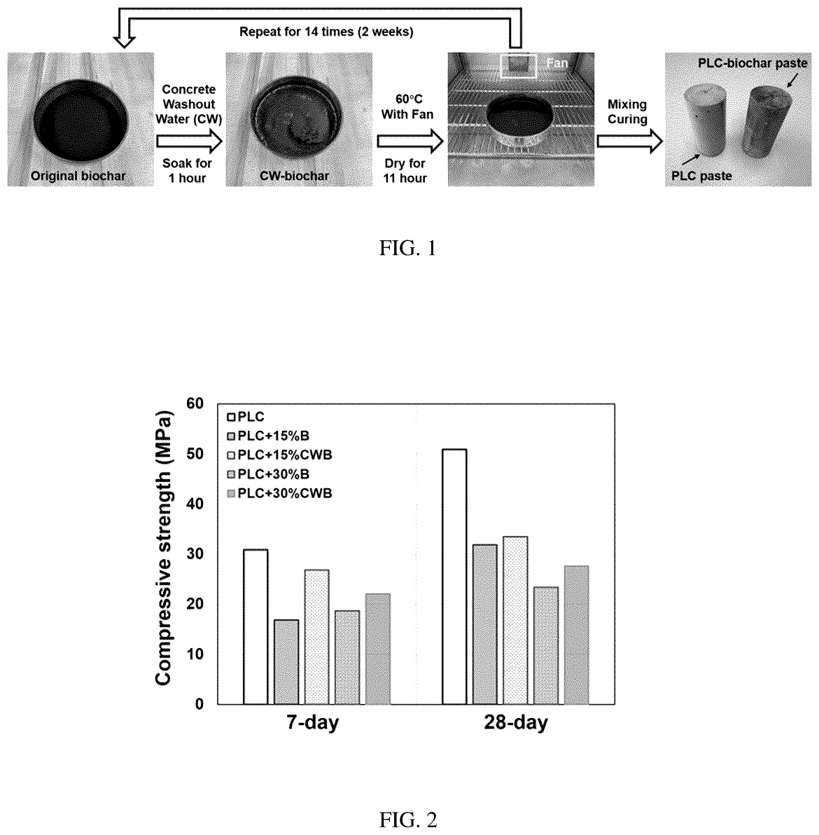

As disclosed herein, ASTM C595 type 1L Portland limestone cement (PLC, SAKRETE™), and a polycarboxylate-based high-range water-reducer (HRWR, MasterGlenium® 7920, BASF) at 0.1 wt. % was used to demonstrate an example working embodiment. The concrete washout water (CW) was collected from previous experiments that used type I/II Portland cement, and the supernatant of the collected CW (e.g., having a pH value of 11.9) was used to treat the biochar at, for example, a 2:1 volume ratio. FIG. 1 illustrates a beneficial carbon-capture process disclosed herein. Before mixing, this CO₂-weathered biochar (denoted as CWB) and its counterpart (the original biochar, B) were pretreated, e.g., ball-milled for 1 h at the speed of 250 rpm and in the material/balls volume ratio of 1:2. Ball milling in particular, as used herein, improves the physicochemical properties of, for example, the CO₂-weathered biochar such as total and micropore surface of the material which can enhance the sorption capabilities.

The maximum particle size of the post-milling biochar was approximately 425 micrometers. To provide an understanding of the working embodiments, one control PLC and four types of PLC-biochar samples (PLC+15 wt. % B, PLC+15 wt. % CWB, PLC+30 wt. % B, and PLC+30 wt. % CWB) were fabricated. The PLC and CWB/B were dry-mixed first for 3-5 minutes before adding water (water/total binder mass ratio of 0.35) to wet-mix for another 3 minutes, and the cylindric paste samples (D: 5 cm×H: 10 cm) were subsequently cast, moist-cured, and tested following ASTM C305, C511, and C39, respectively.

Microscopic investigation was conducted on selected hardened paste samples to evaluate the CO₂-capture level and unravel the enhancement mechanism of CO₂-weathering on the PLC-CWB composite. A FEI QUANTAFEG 250 (FEI Company, America) and a VHX-7000 Series optical microscope (Keyence Corp., USA) were employed to elucidate the microstructures. Fourier transform infrared (FTIR) analysis (Nicolet® Nexus 8700, Therma Scientific, Waltham, MA) was conducted in the scanning range of 400˜400 cm⁻¹ at the resolution of 4 cm⁻¹, and thermogravimetric analysis (TGA 5500, Waters™, Milford, MA) was conducted at the heating rate of 10° C./min from 50˜1000° C. to elucidate the change of chemical bonds and components in selected biochar and paste samples, respectively.

### Compressive Strength Results

Although the admixed biochar decreased the compressive strength of PLC pastes, the CO₂-weathering of biochar enhanced the 7-day (and 28-day) compressive strength of 15 (30) % biochar-PLC paste by 59.2% (15.5%) and 5.2% (15.3%) respectively for verification of initial thought processes. For example, the PLC+30% CWB achieved a compressive strength of 22.1 MPa and 27.6 MPa at 7 and 28 days, respectively, which surprisingly, more than doubled those reported previously. FIG. 2 illustrates that the admixed biochar decreased the compressive strengths of pastes, which agrees well with prior studies. The strength reductions are due to: 1) weak strength of the biochar that makes it “function as the initiator of micro-defects” under loading, 2) poor ITZ between the biochar and the cementitious matrix facilitating the growth of cracks under loading, and 3) heterogeneous microstructures induced by the biochar.

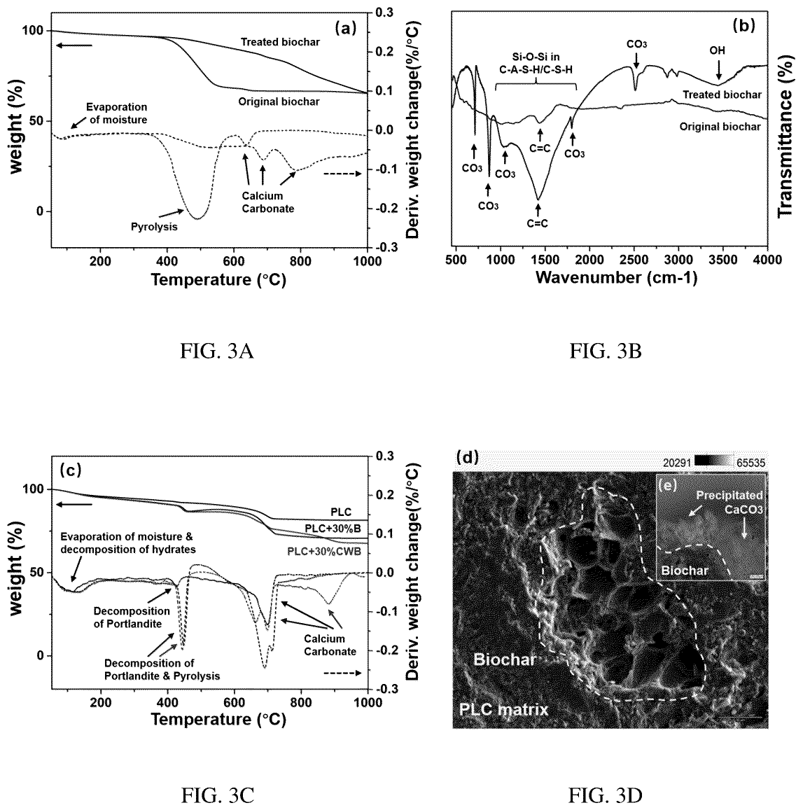

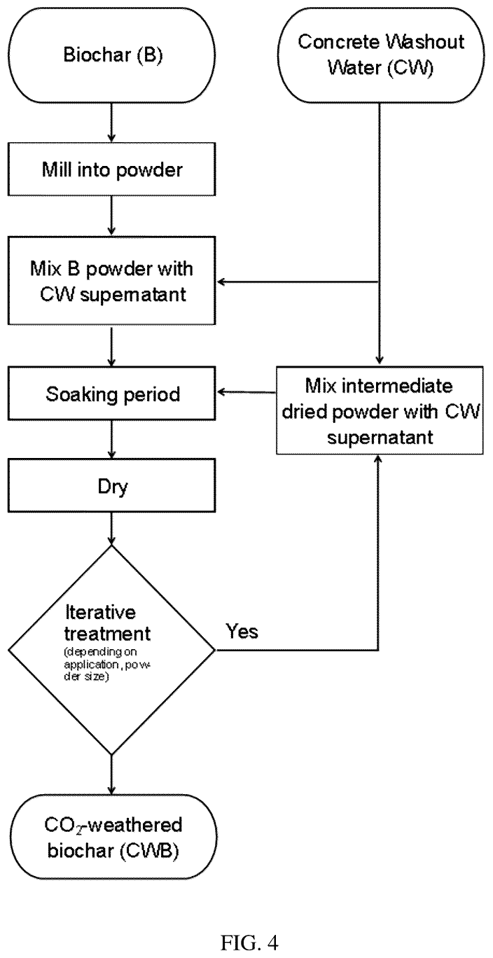

The synergistic carbon-capture of CW and biochar precipitated calcium carbonate onto/into the biochar (see insert FIG. 3D), which not only benefits the material strength of biochar but also improves the ITZ between biochar and PLC paste via the compatibility between calcium carbonate and PLC hydrates. All these mechanisms further benefited the mechanical strengths of the pastes incorporating the CO₂-weathered biochar.

### Microscopic Investigation

FIG. 3 provides the results of the microscopic investigation (TGA/DTG, FTIR, SEM, and optical microscope imaging). FIG. 3A shows the TGA/DTG results of original vis-à-vis treated biochar, featuring significant differences in thermal behavior (especially exceeding 400° C.). For the original biochar, the first mass loss at 50˜100° C. is mainly due to the evaporation of moisture, the second mass loss at 300˜580° C. is likely ascribed to the decomposition of organic components (a.k.a., pyrolysis), and the third mass loss at 600˜700° C. is likely due to the decomposition of calcium calcite. In contrast, the treated biochar exhibited less evident pyrolysis and higher amount of calcium carbonate. The TGA data reveals that 100 g of the original vis-à-vis treated biochar embodied 1.55 g and 24.40 g CO₂ (from the decomposed calcium carbonate), respectively. The higher content of calcium carbonate (and lower content of organic components) explains the better thermal performance of the treated biochar. This result also reveals that the weathering process captured 22.85 g CO₂/100 g biochar.

FIG. 3B depicts the FTIR results of the original vis-à-vis treated biochar. The main chemical bond in the original biochar is C═C whereas carbonate bonds are more dominant in the treated biochar due to precipitation of the captured CO₂.

FIG. 3C depicts the TGA/DTG results of PLC, PLC+30 wt. % B, and PLC+30 wt. % CWB pastes, respectively. The first mass loss is associated with evaporation of moisture and decomposition (or dehydration) of cement hydrates (e.g., C—S—H, C—A—S—H, and Aft). The second mass loss in the PLC paste is due to decomposition of portlandite (CH) whereas that in the PLC+30 wt. % B (CWB) likely comprises both pyrolysis and decomposition of portlandite (including CH as a hydrate of PLC and uncarbonated CH from CW). The multiple mass loss peaks observed between 600˜800° C. mainly stemmed from decomposition of carbonate, and the amount of carbonate in the PLC+30 wt. % B (CWB) was much higher than that in the PLC paste. This resulted from not only the inherent calcium carbonate in the biochar but also the air-borne CO₂-induced carbonation (note that CO₂ can be provided by industrial CO₂, such as carbonic acid) in light of the porous microstructure of PLC-biochar paste (FIG. 3D). Another decomposition of carbonate in the PLC+30 wt. % CWB paste ranges from 750˜950° C., suggesting the CO₂-weathering induced the precipitation of calcium carbonate in a different form (FIG. 3D).

### Analysis of Carbon Footprint

The PLC often includes 15 wt. % limestone and 85 wt. % ordinary Portland cement (OPC), to curtail carbon footprint and energy consumption. The CO₂ footprint of OPC is 0.9 kg/1 kg OPC, and that of PLC is thus 0.77 kg/1 kg PLC (0.210 kg carbon/1 kg PLC). In 1 kg PLC, the introduction of 15 wt. % limestone sequesters another 0.066 kg CO₂ (0.018 kg carbon), and the total carbon footprint is thus 0.192 kg. The carbon content of the original biochar is 32.86% and 1 kg biochar captured 0.2285 kg CO₂ (0.062 kg carbon). As such, 1 kg PLC+30% CWB emits 0.192×0.70=0.1344 kg carbon from the production of PLC, while the CWB reduced 0.3286×0.30=0.098 kg carbon by itself and captured 0.062×0.30=0.0186 kg carbon. FIG. 3C also reveals that the PLC+30% CWB captured about 0.112 kg CO₂ (0.0306 kg carbon) via its carbonation in air, which may increase over time. In summary, the total carbon emissions of 1 kg PLC+30% CWB is estimated to be −0.0128 kg=(0.1344−0.098−0.0186−0.0306) kg. The beneficial use of biochar in concrete also diverts the carbon-rich biomass from alternative pathways (e.g., slash pile burn and chip-and-spread). As such, there is a considerable amount of avoided CO₂ equivalent that is not yet accounted for in the analysis. Otherwise, the carbon negativity of the aforementioned biochar concrete would be more notable.

This approach not only captures and sequesters CO₂ and upcycles two types of waste (CW and B), but also facilitates the industrial application of carbon-negative concrete. After 14 days of weathering, the biochar treated by concrete washout water captured 22.85 wt. % air-borne CO_{2,} and this CO₂-weathered biochar at 30% by weight of Portland limestone cement made the paste carbon-negative.

Microscopic evidence confirms that the captured CO₂ precipitated calcium carbonate into/onto the biochar. This treatment enhanced the 7-day and 28-day compressive strength of 15 (30) wt. % biochar-Portland limestone cement paste by 59.2% (15.5%) and 5.2% (15.3%), respectively.

### Example 2

Task 1: Achieving a carbon-negative biochar concrete by replacing 10% of the cement and 10% of the sand

Task 2: Achieving a carbon-negative biochar concrete by replacing 5% of the cement and 10% of the sand

Task 3: Generating graphene-oxide-like chemistry on surface of biochar before use in cementitious composites

Task 4: Grafting certain functional groups onto the biochar using chemical agents at ambient temperature

Task 5: Developing carbon-negative cellular concrete using biochar.

Materials. The experimental investigation utilized the ASTM C150Type IL portland limestone cement and coarse aggregates with a maximum nominal size of 3/8″ (9.5 mm). A local ready-mix concrete company, Premix-Inc, Pullman, WA, provided the coarse aggregates, and commercial multi-purpose sand was used as the fine aggregates. The corresponding specific gravity ASTM C127 and water absorption ASTM C128 of the coarse aggregates and sand are 2.69 (1.21%) and 2.65 (4.68%), respectively. The grain size distributions of coarse aggregate and fine sand from sieve analysis in accordance with ASTM C136 are presented in Table 2. The apparent water-cementitious material ratio (w/cm) of the concrete mix is 0.4; the sand/cementitious binder mass ratio is 2.0; the coarse-to-fine-aggregate mass ratio is 1.75. OurCarbon™ supplied the biochar utilized in this study, which is derived from the pyrolysis of organic waste (BioforceTech). Note that the biochar is dried and sieved before mixing, and the biochar passing the No. 100 sieve (finer than 150 microns) was used as cement replacement, and the rest (ground to be finer than 4 mm) was used as sand replacement. At the time of casting, the coarse aggregate was in saturated surface dry condition, and the fine aggregates recorded a moisture content of 0.09%. Polycarboxylate-based high-range water-reducing admixture (HRWRA), by BASF Construction Chemicals, LLC, MasterGlenium® 7920, was also used to achieve the desired workability. The HRWRA content varied between 0.1-0.3% by weight of cementitious material to obtain a slump of at least 2.36″ (60 mm).

TABLE 0
Grain size distribution of aggregates (cumulative % passing)

| | | |
|---|---|---|
| Sieves, mm (mesh) | Coarse aggregate | Fine aggregate |

| | | | |
|---|---|---|---|
| 12.5 | (½″) | 100 | — |
| 9.53 | (⅜″) | 93 | — |
| 4.75 | (#4) | 14 | 100 |
| 2.36 | (#8) | 2 | 93 |
| 1.18 | (#16) | 0.1 | 83 |
| 0.6 | (#30) | — | 49 |
| 0.3 | (#50) | — | 15 |
| 0.15 | (#100) | — | 3 |
| 0.075 | (#200) | — | 1 |

| | | |
|---|---|---|
| Specific Gravity | 2.69 | 2.65 |
| Water Absorption, % | 1.21 | 4.68 |

TABLE 3
Concrete mix proportions for different specimen categories (lb/yd³)

| | 100% | BC5%- | BC10%- | SF-BC10%- | | |
|---|---|---|---|---|---|---|
| | Cement | BS10% | BS10% | BS10% | BC5% | BC10% |
| Cement | 767 | 728 | 690 | 613 | 728 | 690 |
| Fine Aggregate | 1534 | 1380 | 1380 | 1380 | 1534 | 1534 |
| Coarse Aggregate | 2684 | 2684 | 2684 | 2684 | 2684 | 2684 |
| Water | 307 | 307 | 307 | 307 | 307 | 307 |
| Fine Biochar | — | 38 | 77 | 77 | 38 | 77 |
| Coarse Biochar | — | 153 | 153 | 153 | — | — |
| Silica Fume | — | — | — | 77 | — | — |

Methods: Biochar preparation. For Tasks 1 and 2, the biochar was first modified to enhance its properties as a construction material before being incorporated into the concrete mix. The initial untreated biochar is soaked in concrete washout water (2:1 volume ratio) for one hour. After that, the biochar is subjected to an 11-hour drying period at 60° C. in an oven equipped with a fan. This 12-hour cycle was completed once for one time treated (1T-) and thrice for three times treated (3T-) biochar that is used in this study. Following the drying phase, the biochar is ground for 10 seconds using an industrial spice grinder. After grinding, the fine portion of biochar that passes through the #100 sieve is collected for use as a substitute for cement. The coarse biochar that is retained on the #100 sieve is collected to use for sand replacement. Note that this coarse biochar entirely passes through the #4 sieve.

For Tasks 3 and 4, the main chemical functional groups of graphene oxide are —COOH or —OH. Therefore, these two tasks share a similar technology plan, involving the use of hydrogen peroxide (H₂O₂) and potassium permanganate (KMnO₄) to oxidize the biochar, graft —COOH or —OH groups, and thereby introduce graphene-oxide-like chemistry onto the surface of the biochar. Additionally, to distinguish between these two tasks, we employed sodium hydroxide (NaOH) to pretreat the biochar in task 4, with the aim of grafting more-OH functional groups. Two types of biochar were selected: one (B1) provided by OurCarbon™ and the other (B2) was a wheat-straw derived biochar by Qualterra, Spokane Valley, WA. Initially, all biochar was ground to be less than 125 μm before chemical treatment (i.e., oxidation and functional group grafting). The types, concentrations, and treatment times are illustrated in Table 4. After chemical treatment, all biochar was washed multiple times until the pH value of the washout water approached 7.0. Subsequently, all treated biochar was dried before utilization and ready to replace portland limestone cement (PLC).

TABLE 4
Grain size distribution of aggregates (cumulative % passing)

| Chemical Agent | Concentrations | Treating times (hours) |
|---|---|---|
| H₂O₂ | 5% | 6 |
| | | 12 |
| | 10% | 6 |
| | | 12 |
| KMnO₄ | 1% | 6 |
| | | 12 |
| | 5% | 6 |
| | | 12 |
| NaOH | 5% | 6 |
| | | 12 |
| | 10% | 6 |
| | | 12 |

Note:
H₂O₂, KMnO₄, NaOH are noted as HO, KM, and Na. For example, HO-C5-6 means using 5% concentration of H₂O₂ to treat for 6 hours.

For Task 5, the modification of biochar is similar to that in Tasks 1 and 2 but with different weathering cycles. The 12 hour cycle was completed 6 times. In addition, to guarantee the pore structure of targeted cellular concrete, no further grinding was conducted in this task.

Mixing procedure and specimen preparation. For Tasks 1 and 2: First, the coarse aggregates are pre-soaked in water for at least 48 hours and towel-dried to achieve saturated surface dry (SSD) conditions. Once the material quantities are measured, the mixing water is divided into three parts. One part is used to pre-soak the fine biochar, ensuring sufficient water to cover its surface. The second part of the water is used to pre-soak the coarse biochar. Note that water is added to biochar for pre-soaking about 30 minutes before mixing. A small portion of the remaining water is combined with the HRWRA, while the remainder is incorporated in the mixing stage. First, the coarse aggregates are placed in the mixing drum and mixed for a few revolutions. Then, the HRWRA is added, followed by sand, cement, and water. Finally, the pre-soaked biochar is added to the drum and mixed for five minutes. The concrete samples with a diameter of 4″ (100 mm) and height of 8″ (200 mm) were subsequently cast, cured in a lime-saturated water bath, and tested following ASTM C39 and C143, respectively.

For Tasks 3 and 4: The mix proportion of all biochar-PLC paste was biochar: PLC=20:80 in mass, and water to all solid materials mass ratio was 0.40; the polycarboxylate-based superplasticizer was used during the mixing process to achieve reasonable flowability of the paste. Before mixing, biochar was pre-saturated in water. The preparation of these biochar-PLC paste samples followed the specification of ASTM C192, the fresh paste was cast in the cylindrical molds in the size of 5 cm (diameter)×10 cm (height). After hydration hardening 24 hours later, all hardened paste samples were demolded and cured in the standard environment for additional 27 days for the compressive strength testing following ASTM C39.

For Task 5: By following our previous research (Li et al., 2017), the foaming agent (Alpha olefin sulfonate: AOS) and foaming stabilizer agent (Sodium phosphate: Na₃PO₄) were used in this task. The mixture design of control PLC foamed paste was PLC:AOS:Na₃PO₄=200:5:2, and the water to binder ratio was 0.3 in mass. The 30 wt. % replacement of biochar, either carbonated or original, to PLC was selected to prepare PLC-biochar foamed paste. First of all, the measured water, AOS, and Na₃PO₄ were blended to achieve the solution, then this solution was divided into three parts and added into the dry binder at 2 min time intervals. After all solution was poured into the mixer (at 4 min), the speed of mixer was adjusted to fast mode with additional 4 min mixing to achieve fresh foamed paste. Then this paste was cast into the cylindrical mold in size of 5 cm (diameter)×10 cm (height) for the compressive strength test, and the plate mold in size of 2.5 cm (height)×10 cm (width)×10 cm (length) for the thermal conductivity test. After 28-day curing, all samples were dried for 24 hours before the testing. Table 5 provides the information of designed cellular concrete.

TABLE 5
Designed mix proportion of cellular concrete (unit: g)

| | | | | | | PVA |
|---|---|---|---|---|---|---|
| | PLC | biochar | AOS | Na₃PO₄ | Water | fiber |
| Sample 1 | 800 | — | 20 | 8 | 240 | — |
| Sample 2 | 560 | 240 | 20 | 8 | 240 | — |
| Sample 3 | 560 | 240 (carbonated) | 20 | 8 | 240 | — |
| Sample 4 | 560 | 240 | 20 | 8 | 240 | 5 |
| Sample 5 | 560 | 240 (carbonated) | 20 | 8 | 240 | 5 |

### Results and Discussion

For tasks 1 and 2: Achieving a carbon-negative biochar concrete by replacing the cement and the sand.

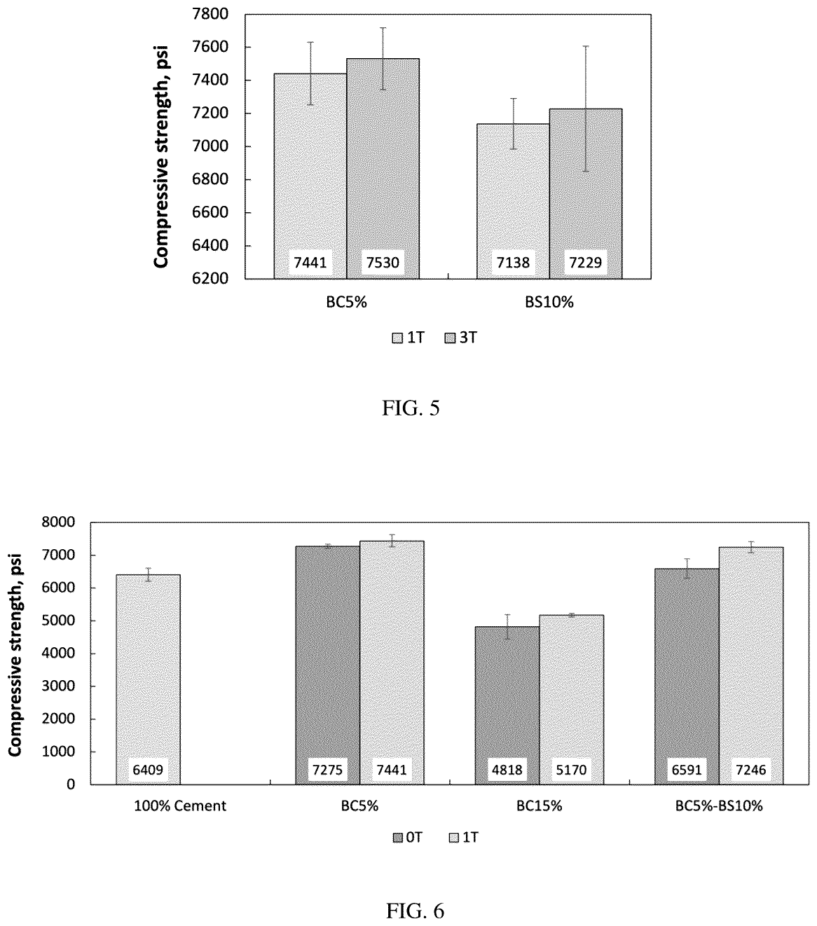

Throughout this discussion, the concrete mixes incorporating untreated, once-treated, and thrice-treated biochar are denoted by the prefixes 0T-, 1T-, and 3T-, correspondingly. FIG. 5 presents an overview of the compressive strengths of concrete incorporating 1T-vs. 3T-biochar. However, after two additional pre-treatment cycles (in 3T-compared to 1T-), the compressive strength of biochar concrete with 5% and 10% cement replacement experiences only marginal increments of 89 psi (1.20%) and 91 psi (1.27%), respectively. Therefore, in the remainder of the study, only 1T-biochar will be used for comparisons.

FIG. 6 illustrates the compressive strength of various biochar concrete samples at 5% and 15% replacement. Notably, the 1T-compressive strength exceeds 0T-, demonstrating increases of 2.27%, 7.32%, and 9.94% for BC5%, BC15%, and BC5%-BS10% biochar concrete samples, respectively. Additionally, the data indicates that substituting 5% of 1T-fine biochar for cement and 10% of 1T-coarse biochar for sand leads to a 40.2% increase in concrete compressive strength compared to replacing 15% cement with fine biochar. This observation implies an enhanced potential for achieving carbon neutrality by the combined replacement of cement and sand with biochar. This could be mainly due to sand occupying a large mass in the concrete mix, leading to a sizeable coarse biochar quantity when replacing sand. The coarse biochar (retained on a 150 μm sieve) is much finer than the sand particles in this study. Hence, substituting biochar for sand increases the fine particles in the mix, leading to better packing and increased strength. Additionally, biochar absorbs a significant amount of moisture, and since we did not perform a moisture correction, this change significantly reduces the water/cementitious materials ratio, further increasing the strength.

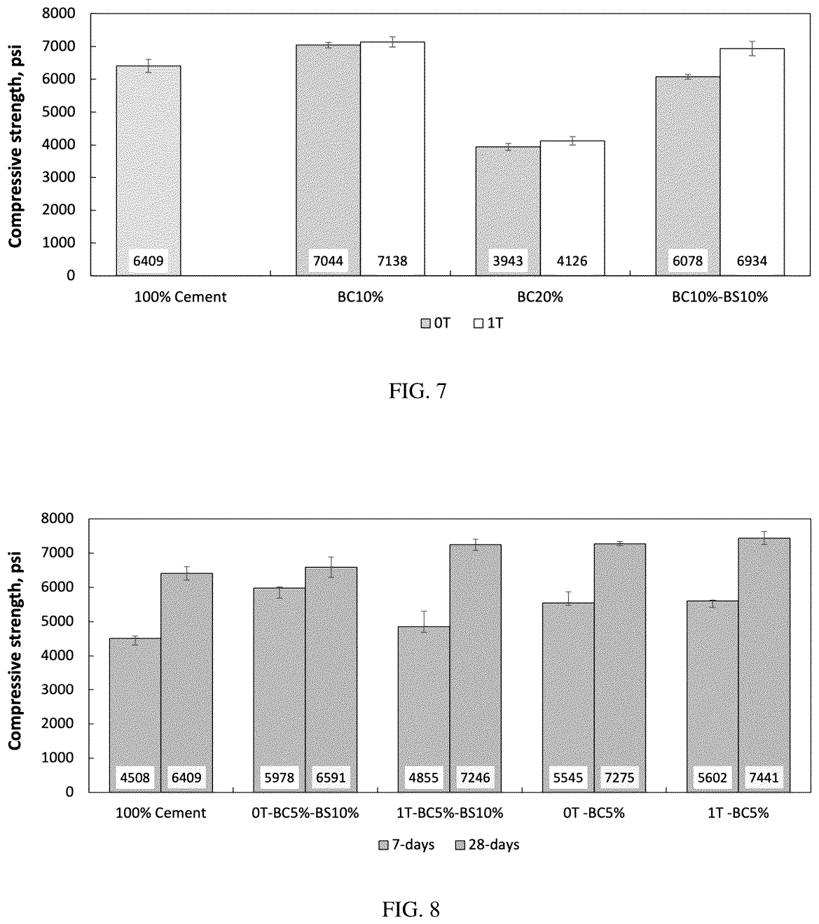

FIG. 7 illustrates the compressive strengths of different biochar concrete samples at 10% and 20% biochar replacement. Notably, the biochar treated once exhibits superior compressive strength compared to untreated biochar, showing increases of 1.33%, 4.64%, and 14.1% for BC10%, BC20%, and BC10%-BS10% samples, respectively. Additionally, it is evident that substituting 10% of 1T-fine biochar and 10% of 1T-coarse biochar (a total of 20%) results in a 68.1% increase in concrete compressive strength compared to substituting 20% fine biochar for cement. This further reinforces the observation that the combined replacement of cement and sand with biochar enhances properties while achieving carbon neutrality. Similar reasons, as explained in FIG. 6. Concrete compressive strengths for different biochar dosages at 15% by weight replacement, may have influenced this behavior.

FIG. 8 illustrates the changes in compressive strength for concrete samples with a 5% replacement of biochar based on the weight of the cement. Overall, adding biochar, whether treated or untreated, has enhanced the compressive strength of the specimens. It is important to note that in this experiment, the water content of the mix remained constant for different types of biochar (0T-, 1T-, and 3T-), while workability was adjusted using HRWRA. Despite the differences in moisture absorption, no moisture correction was performed for the biochar.

The untreated biochar has a more significant impact on workability than 1T- and 3T-biochar. At seven days, the 0T-BC5%-BS10% specimen exhibited a 32.6% increase in compressive strength compared to the control (100% cement sample). However, the 28-day compressive strength of the 0T-specimens was only 2.84% higher than the corresponding 28-day compressive strength of the concrete.

In contrast, the 1T-BC5%-BS10% recorded a 7.69% and 13.1% increase in strength over the control group of mortar samples at 7 and 28 days, respectively. The 0T-samples indicated a higher compressive strength at seven days but lower strength at 28 days compared to the 1T-samples. The initial higher strength of 0T-samples may be attributed to the untreated biochar's high water retention capacity in early-age concrete, effectively reducing the mix's water/cement ratio and increasing compressive strength. However, over time, the gradual release of moisture (internal curing mechanism) may have reduced comparative compressive strength after 28 days. For the 1T-samples, the primary factor influencing strength is the calcium carbonates (solids) that enhance the strength of biochar concrete. FIG. 8 also indicates that the addition of 10% biochar as a sand replacement reduced the 28-day compressive strength of biochar concrete by 10.4% and 2.61% compared to the corresponding BC5% and BC10% samples.

The target values of biochar concrete samples' 7-day and 28-day compressive strength were 3950 psi and 5010 psi, respectively. However, the experimental 7-day and 28-day compressive strength measured 5978 psi and 6591 psi, exceeding the expected values by 51.3% and 31.6%, respectively. This substantial variation could be attributed to the absence of moisture correction on added fine or coarse biochar during mixing, potentially leading to a lower water/cementitious material ratio and increased strength.

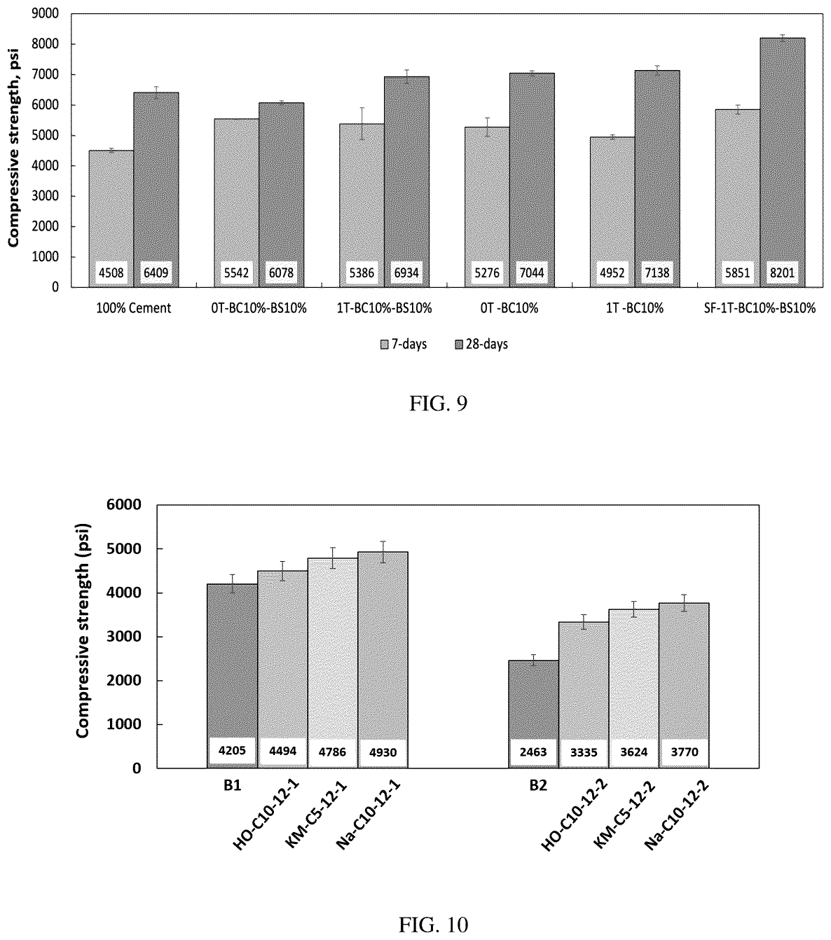

FIG. 9 indicates the variation of compressive strength at 7 and 28 days for biochar cement replacement of 10% by weight. Similar to previous findings, the untreated biochar outperformed 1T-biochar at seven days by 2.81% and 6.14% for the BC10%-BS10% and BC10% samples, respectively. However, after 28 days, the untreated (0T-) samples showed a 5.17% reduction in strength for BC10%-BS10% and a 1.58% increase in strength for BC10% compared to the control. In contrast, the 1T-samples exhibited compressive strength gains of 14.1% and 1.33% for BC10%-BS10% and BC10%, respectively.

The targeted compressive strengths at 7 and 28 days for the combined 10% fine biochar and 10% coarse biochar were 5640 psi and 6050 psi, respectively. According to FIG. 9, the biochar concrete achieved this goal, demonstrating 6.0% and 8.9% higher compressive strengths at 7-day and 28-day, respectively, compared to the expected values. To further enhance the mechanical properties of biochar concrete, approximately 10% silica fume by weight of cementitious materials was incorporated into the mix to achieve the intended 28-day compressive strength of 8,200 psi.

For tasks 3 and 4: Chemical treatment to modify the surface properties of biochar for use in cementitious material composite.

FIG. 10 shows the 28-day compressive strength of selected PLC paste with various chemically treated biochar. While the introduction of biochar in PLC paste resulted in a decrease in compressive strength, the chemical treatment contributed to the strength improvement relative to using untreated biochar. The compressive strength results indicate that a longer treatment time and a higher concentration of the chemical solution led to greater strength enhancement. This is likely due to the higher content of functional groups (—COOH and —OH) grafted during the treatment process with longer times and higher solution concentrations. These grafted functional groups act as growth templates, accelerate the hydration process, and control the formation of more homogeneous hydrates. All these benefits enhance the properties of weak interfacial transition zone between biochar and PLC paste.

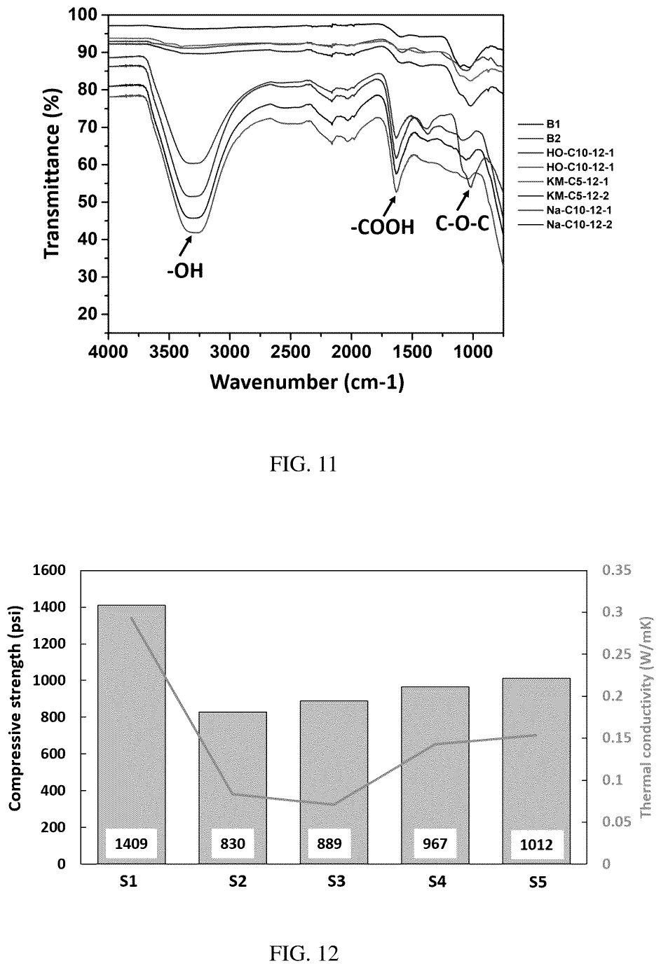

In FIG. 11, the Fourier Transform Infrared spectroscopy (FTIR) patterns of selected biochar samples demonstrate the presence of grafted functional groups, providing insight into the aforementioned mechanism of strength enhancement. Interestingly, chemical treatment also improves the workability of biochar-PLC paste. For instance, when using the hydrophobic B2, more HRWRA was needed to ensure the workability met practical requirements. However, after treatment, the grafted —COOH and —OH transform the biochar surface to be hydrophilic, achieving desirable workability without additional HRWRA.

For task 5: Carbon-negative cellular concrete with biochar incorporated.

FIG. 12 illustrates the 28-day compressive strength and thermal conductivity coefficient of the fabricated cellular concrete. Sample 3 stands out among all the fabricated cellular concrete, exhibiting acceptable strength and the lowest thermal conductivity, while sample 5 stands out among all biochar-incorporated cellular concrete because of its highest strength and acceptable thermal conductivity. These properties also meet the general requirements for building thermal insulation materials. In comparison to conventional organic thermal insulation materials, this biochar-PLC exhibits higher fire resistance due to its inorganic nature and built-in porosity, translating to safety and resiliency benefits in case of a fire scenario. By adjusting the foaming time, the cellular concrete can be tailored for various applications, such as refilling road bases, foundation pits, and mining pits, which were traditionally done using soil and concrete. In addition to the carbon credit built in the biochar cellular concrete, the use of cellular concrete avoid the risk of sinking associated with soil filling technology and is more cost-effective than using conventional concrete.

### Example 3

A carbon-negative biochar concrete can be obtained by replacing 10% of the cement and 10% of the sand. Water/cementitious binder mass ratio of 0.40; sand/cementitious binder mass ratio of 2.0; coarse-to-fine-aggregate mass ratio of 1.75. Note that the biochar was dried and sieved before mixing; and the biochar passing the No. 120 sieve (i.e., finer than 125 microns) was used as cement replacement and the rest (ground to be finer than 4 mm) was used as sand replacement.

Depending on the type of biochar used, the 7-day and 28-day compressive strength of the biochar concrete was up to 5,640 psi and 6,050 psi, that is, 45-110% and 75-110% that of the control group (without biochar), respectively. If the biochar is pretreated with limewater and/or other materials, the 28-day compressive strength of concrete with 10% biochar fine aggregate can reach 8,200 psi.

The dosage of fine biochar (finer than 125 microns) is controlled to range from 1˜20 wt % of cement and the dosage of coarse biochar is controlled to range from 0˜20 wt % of fine aggregate.

One can use nanomaterials (e.g., 1 wt. % nanoclay) and supplementary cementitious materials (e.g., 15 wt. % fly ash) along with limewater to pre-treat biochar, so that the resulting biochar overcomes the limitation of its original weak strength and becomes a strong fine aggregate (comparable to regular fine aggregate).

### Example 4

A carbon-neutral biochar concrete can be obtained by replacing 5% of the cement and 10% of the sand. Water/cementitious binder mass ratio of 0.40; sand/cementitious binder mass ratio of 2.0; coarse-to-fine-aggregate mass ratio of 1.75. Note that the biochar was dried and sieved before mixing; and the biochar passing the No. 120 sieve (i.e., finer than 125 microns) was used as cement replacement and the rest was used as sand replacement.

Using the concrete-washing water to soak biochar which then capture airborne CO₂ and form nano- and micron-sized carbonate precipitate onto or into the biochar before its mixing in the fresh concrete. This strategy not only upcycles two types of waste to develop sustainable construction material but also decreases the CO₂ footprint of the final product. In one example, the 7 d and 28 d compressive strength of cement paste containing 15 wt. % CO₂-weathered biochar reached up to 3950 psi and 5010 psi, respectively, which meet the requirements of some application scenarios.

### Example 5

We used high temperature (or ambient temperature), high pressure, and oxidizing agent to generate graphene-oxide-like chemistry on the surface of biochar, before the use of biochar in cementitious composite. We used single or simultaneously/successively combined oxidizing agents to oxidize the biochar and then washed them several times until the pH of washing water reached 7. The acid-treated fine biochar was used to replace 20 wt. % of cement in an ordinary portland cement paste (water/binder mass ratio of 0.40) and it exhibited comparable 28 d compressive strength (6816 psi), relative to the original cement paste.

### Example 6

We used several chemical agents or high-energy beam at ambient temperature to graft certain functional groups (—COOH, —OH) onto the biochar surface and thus enhance the interface between biochar and cementitious matrix. The surface-modified fine biochar was used to replace 10 wt. % of cement in an ordinary portland cement paste (water/binder mass ratio of 0.40) and it exhibited comparable 28 d compressive strength (7250 psi), relative to the original cement paste.

### Example 7

We used a small amount of nanomaterials to modify biochar, on the surface or inside, to enhance the performance of biochar concrete. For instance, the nanomodification of biochar (by 2 wt. % montmorillonite nanoclay) compensated for the defects of the original biochar and achieved a 28 d compressive strength of 7000 psi for the concrete incorporating 20% fine biochar by weight of cement, which is comparable to that of the control concrete without any biochar.

### Example 8

The biochar concrete and other biochar cementitious composites can be cured at the early stage (e.g., at 0.5 to 4 hours) at ambient temperature for a given time (e.g., 30 minutes) in the presence of concentrated CO₂ (e.g., 20 to 40%) to induce the formation of nano-/micron-sized carbonate and improve the strength and durability of the material. Depending on the type of biochar used, the 7-day and 28-day compressive strength of the biochar concrete was improved by up to 15 to 25% by the CO₂ curing process. If the biochar cementitious composite was pervious concrete or cellular concrete, then the strength improvements are more notable, in the range of 25 to 50%.

### Example 9

TABLE 6
Carbon-negative, strain-hardening engineered cementitious composite (ECC)

| | | fly | silica | | | | | PE |
|---|---|---|---|---|---|---|---|---|
| | Cement | ash | fume | biochar | sand | water | Superplasticizer | fiber |
| Ref.-ECC | 810 | 486 | 133 | 0 | 430 | 279 | 18 | 19 |
| B05 (5%) | 769.5 | 486 | 133 | 40.5 | 430 | 279 | 18 | 19 |
| B10 (10%) | 729 | 486 | 133 | 81 | 430 | 279 | 18 | 19 |
| B20 (20%) | 648 | 486 | 133 | 162 | 430 | 279 | 18 | 19 |
| B30 (30%) | 567 | 486 | 133 | 243 | 430 | 279 | 18 | 19 |

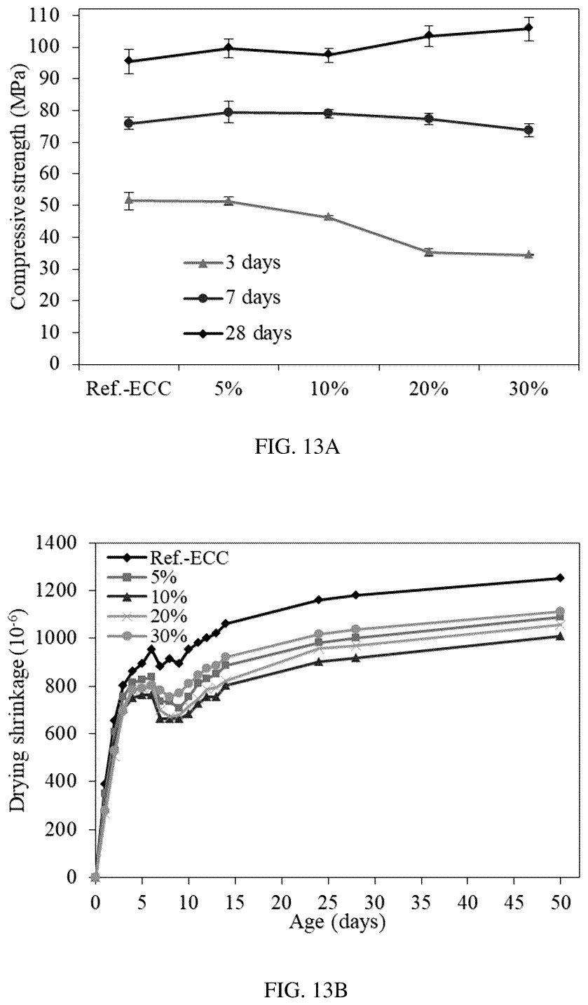

Relative to the control (Ref.-ECC), FIG. 13A shows that the 28-day compressive strength of biochar-modified specimens were all slightly higher, even though their 3-day compressive strength were 10% to 40% lower. FIG. 13B shows the total shrinkage of ECC specimens for 50 days and the specimens with a cement replacement of 10% by fine biochar showed the largest reduction in the total shrinkage (by 20%). Note that the water-to-binder ratio of the ECC was 0.195, i.e., autogenous shrinkage was the dominant contributor to the total shrinkage. These results confirmed the effectiveness of biochar for internal curing of the ECC.

### Example 10

Carbon-negative cellular concrete is a cost-effective and sustainable approach to refilling road base, foundation pits, and mining pits, in place of soil refilling or concrete refilling. The cellular concrete is produced through the use of foaming agent(s) and features lightweight and porous properties. Depending on the specific mix design (and if needed, coupled with the CO₂ curing), the cellular concrete can be produced with a 28 d compressive strength of 145 psi (1 MPa) to 1450 psi (10 MPa) and would not significantly sink when exposed to water, which meet the requirements of filling materials. The thermal conductivity of cellular concrete can range from 0.05 W/mK to 0.25 W/mK, which meets the requirements of thermal insulation material. The cellular concrete can also be used for sound insulation, e.g., as noise barrier, and fire-resistant material.

### Example 11

Carbon-neutral shotcrete can be produced by incorporating biochar into the fresh mixture. Such specialty concrete is useful for repairing and enhancing the weak slopes (both cut and full slopes) and retaining walls. We mixed modified biochar into fresh shotcrete, The 28 d compressive strength of this 20% biochar-cement concrete reached up to 4950 psi (35 MPa), no obvious rebound and promising adhesion.

An example control mix design for shotcrete is as follows. Cement:fine aggregate=1:3.5˜4.5, water to cement ratio =0.42˜0.50, and a certain amount of viscosity-modifying admixture and/or fibers.

### Example 12

Low carbon footprint, vegetation-growing shotcrete can be produced by incorporating biochar into the fresh mixture. Such specialty concrete is useful for repairing damaged ecosystems. We filled some nutrients and vegetation seeds into the biochar, then mixed the biochar into fresh concrete, before using it for vegetation growth. We employed a vacuum to absorb the solution with necessary nutrients and seeds into the coarse biochar and then mix them with cement, fine biochar (original or modified), and admixtures (or fibers) to fabricate vegetation cellular shotcrete. The 28 d compressive strength of this 50% biochar-cement cellular concrete reached up to 2175 psi (15 MPa) and can be used for the growth bed of alkali-resistant plant species.

### Example 13

Carbon-neutral 3D printable concrete can be produced by incorporating biochar into the fresh mixture. Such specialty concrete is useful for pre-casting concrete parts, in-situ casting new structure or repairing/enhancing the aged concrete structure. We mixed the modified biochar into fresh 3D printable concrete. The 28 d compressive strength of this 20% biochar-cement concrete reached up to 4950 psi (35 MPa) and met the requirement of plasticity.

An example control mix design for 3D printable concrete is as follows. Cement:fine sand=1:1.5˜2.5, SCM:cement=0˜1.5:2.5, water to cement=0.15˜0.25, and a certain amount of viscosity-modifying admixture, nanomaterials and/or fibers. The SCM could be fly ash, silica fume, calcined clay, limestone powder, or waste glass powder.

### Example 14

Carbon-neutral building comprises timber-concrete composite and can be produced by incorporating biochar into the concrete part. Such specialty concrete is useful for casting on the timber floor to serve as protection and enhance the integrity of composite structure under external load (e.g., earthquake and wind). We mixed the modified biochar into concrete. The 28 d compressive strength of this 40% biochar-cement cellular concrete reached up to 2175 psi (15 MPa) and can be used in the timber-concrete composite.

An example control mix design for concrete is as follows. Cement:fine aggregate=1:3.5˜4.5, fine aggregate:coarse aggregate=1:2˜4, water to cement ratio=0.42˜0.50, and a certain amount of SCM, concrete admixtures, nano-sized material (as admixture), and/or fibers, if necessary.

### Example 15

Carbon-neutral mortar for masonry can be produced by incorporating biochar into the fresh mortar mixture. We mixed the modified biochar into fresh mortar, the 28 d compressive strength of this 30% biochar-cement mortar reached up to 3115 psi (21.5 MPa) and can be tailored and then used for all types of mortar.

An example control mix design for masonry mortar is as follows. cement:fine aggregate=1:3.0˜4.0, SCM:cement=0˜1:2.0, water:cement=2.5˜3.5:1, and a certain amount of SCM, concrete-adaptive chemical/nano-admixture, and/or fibers, if necessary.

### Example 16

Carbon-neutral biochar cement can be used to modify the original structure of weak soil, like expansive soil or collapsible soil, and then strengthen/stabilize them. We mixed the modified biochar-cement into weak soil, the 5% cement containing 40 wt. % biochar mitigated the expansion of expansive soil by 60%, and mitigated the sinking of collapsible soil by 50%, respectively.

An example control mix design for paste is as follows. Water:cement=2.5˜3.5:1, and a certain amount of SCM, concrete-adaptive chemical/nano-admixture, and/or fibers, if necessary.

### Example 16

### Multiple Carbonation Process

Carbonated biochar: Mix dried biochar with precipitate (cement paste) of waste concrete washout slurry, add and blend extra washout water supernatant, then inject CO₂ gas until pH reaches neutral (pH=7). Dry and mill for use.

Carbonated recycled concrete aggregate (RCA) (Both fine and coarse): Soak and stir RCA in pure water, introduce CO₂ into the mixture when stirring until the pH of the solution becomes neutral (7), then dry it for use.

Carbonated water (Waste washout water): Inject CO₂ into collected washout water until pH reaches neutral, and ultrasonically disperse before use (like hybrid micro/nano-CaCO₃ solution). Note: the washout water can be replaced by other alkali waste.

Carbon Capture estimation

After estimation and calculation, (60% portland limestone cement+40% original biochar)+(30% carbonated fine RCA+70% original fine RCA)+carbonated alkaline water can lead to carbon-negative mortar, with a carbon footprint of −0.007124 ton per ton of mortar.

(60% portland limestone cement+40% original biochar)+(30% carbonated fine RCA+70% original fine RCA)+(30% carbonated coarse RCA+70% original coarse RCA)+carbonated alkaline water can lead to carbon-negative concrete, with a carbon footprint of −0.00645 ton per ton of concrete.

### Example 17

### Experimental

### Materials

Given the limited supply and significant CO₂ emissions associated with type I/II ordinary portland cement (OPC), this study utilizes portland limestone cement (PLC: 85wt. % OPC+15wt. % limestone) to mitigate the CO₂ footprint of the cement/concrete industry. The fine natural aggregate utilized in this research was sourced from Bonsal American Inc. (Charlotte, NC) and purchased from a local building supply. The biochar utilized was provided by OurCarbon™, and its chemical composition was analyzed via XRF, as detailed in Table 7. Recycled concrete aggregate (RCA) was obtained from our previous waste OPC paste samples (OPC:water=1:0.5 in mass ratio) with the aim of partially replacing natural fine aggregate. Additionally, washout paste slurry, another byproduct of the concrete industry, was earmarked for upcycling in this study to further facilitate CO₂ sequestration. To ensure experiment repeatability, we simulated the washout slurry in the laboratory with a fixed ratio of raw materials, as detailed below.

TABLE 7
Chemical component of biochar provided by OurCarbon ™
Component (wt. %)

| Elemental Ash Content (~66 wt/%) contains mainly inorganic matters | | | | | | | | | | | |
|---|---|---|---|---|---|---|---|---|---|---|---|
| SiO₂ | Al₂O₃ | TiO₂ | Fe₂O₃ | CaO | MgO | Na₂O | K₂O | P₂O₅ | SO₃ | Cl | Carbon |
| 27.43 | 12.19 | 1.68 | 14.08 | 14.10 | 3.17 | 1.70 | 1.04 | 1613 | 7.77 | 0.01 | (32.86%) |

### Multiple Carbonation Process

The study examines a multiple-carbonation process, involving the carbonation of biochar, alkali wastewater, RCA, and CO₂ curing for fabricated mortar samples. This process mainly utilizes alkali, either extra-added or inherent, and CO₂ gas to achieve carbonation and finally facilitate the carbon-negative goal. To ensure experimental consistency and repeatability, we simulated the washout paste slurry, a waste byproduct of the concrete industry, using a fixed mass ratio of PLC to water at 1:5.

The supernatant and precipitate of this simulated washout paste slurry were collected for various usages. After approximately 12 hours of settling, the supernatant from the slurry was extracted and prepared for carbonation to serve as the mixing water. A plastic pipe connected the supernatant in a sealed container to a CO₂ gas tank, with carbonation considered complete when the supernatant's pH reached 7 (neutral) from 12. Before use, the carbonated supernatant underwent 10 minutes of ultrasonic dispersion to achieve a hybrid nano-/micro-CaCO₃ suspension which is supposed to enhance the performance of hardened specimens, as widely reported in nano-engineered cement composites.

The slurry precipitate was mixed with biochar to capture and sequester CO₂ in light of its high alkalinity, which was also expected to enhance the weak structure of biochar. The mass ratio of dry biochar to dry paste precipitate was fixed at 2:1, with the water content of the slurry precipitate determined through measurement. Subsequently, additional supernatant, in a volume ratio of 3:1 to dry biochar, was thoroughly blended, and CO₂ gas was injected using the same strategy employed for preparing the carbonated supernatant until the pH reached 7 (neutral). Regular stirring of the biochar-precipitate mixture was essential during underwater carbonation to ensure full contact between CO₂ and alkali. The biochar-precipitate mixture underwent initial air drying followed by oven drying at 100° C. for 24 hours to ensure thorough dehydration. Prior to preparing mortar/concrete specimens, the dried mixture was subjected to ball-milling for 1 hour at a speed of 250 rpm, with a material-to-balls volume ratio of around 1:2.

A similar approach was taken for carbonating RCA. RCA was soaked and stirred regularly in pure water, with a volume ratio of 1:4, for 24 hours. CO₂ gas was then injected into the mixture until the solution's pH reached 7 (neutral). Again, regular stirring of the RCA-water mixture was crucial during underwater carbonation to guarantee full contact between CO₂ and the alkali leached from the RCA. Before use, the carbonated RCA underwent air drying followed by oven drying at 100° C. for 24 hours to ensure thorough dehydration.

### Fabrication of Mortar and Concrete Specimen

The fabrication process of these novel mortar samples is detailed as follows. The natural aggregates and carbonated RCA were dry mixed without water for 5 min, then the PLC and carbonated biochar were added and blended into aggregates until a homogeneous mixture was obtained. Meanwhile, carbonated alkaline water was ultrasonically dispersed for 10 min at 50% amplitude to achieve a hybrid nano-/micro-CaCO₃ suspension, and then poured into the dry mixture and fully blended for 5 min to reach the desired flowability and consistency. The fresh mortar mixture was cast into cylindrical molds in size of 50.8 mm (diameter)×101.6 mm (height) and covered by a plastic lid for 24 hours to avoid any water evaporation. After demolding, all mortar cylinders were moved to a standard curing condition (22±1° C., relative humidity of 95±3%) and cured for 6 days and 27 days for testing the 7-day and 28-day compressive strength, respectively. The mixture combinations of mortar specimens are presented in table 8.

TABLE 8
Mixture combinations of mortar specimens (wt. %).

| Specimen No. | 1 | 2 | 2(C) | 4 | 5 | 6 | 7 |
|---|---|---|---|---|---|---|---|
| PLC | 100 | 70 | 70 | 70 | 60 | 60 | 60 |
| CBiochar | / | 30 | 30 | / | 40 | / | / |
| Biochar | / | / | / | 30 | / | 40 | 40 |
| Natural | 300 | 240 | 240 | 240 | 210 | 210 | 210 |
| Aggregate (F) | | | | | | | |
| CRCA (F) | / | 60 | 60 | 60 | 90 | 90 | / |
| RCA (F) | / | / | / | / | / | / | 90 |
| Tap water | 50 | / | / | 50 | / | / | 50 |
| CWater | / | 50 | 50 | / | 50 | 50 | / |

Note: CBiochar, CRCA, and CWater mean carbonated biochar, RCA, and alkaline water, respectively; 2(C) means specimen No.2 underwent CO₂-curing; and (F) means fine aggregate.

The fabrication process for concrete samples is similar to that of mortar samples but incorporates coarse aggregate. Furthermore, the water-to-binder ratio for concrete samples was fixed at 0.35 to satisfy the demands of concrete mixtures in chloride-laden cold regions. Based on the results from mortar specimens, all RCA were carbonated before use. To ensure favorable workability, a high-range water reducer (HRWR) was utilized during the concrete fabrication process. Table 9 provides the mixture combination of various concrete specimens.

TABLE 9
Mixture combinations of concrete specimens (kg/m³).

| Specimen No. | A | B | C | D | E |
|---|---|---|---|---|---|
| PLC | 125.07 | 87.55 | 87.55 | 75.04 | 75.04 |
| CBiochar | / | 37.52 | / | 50.03 | / |
| Biochar | / | / | 37.52 | / | 50.03 |
| Natural Aggregate (F) | 187.83 | 150.26 | 150.26 | 131.48 | 131.48 |
| CRCA (F) | / | 37.57 | 37.57 | 56.35 | 56.35 |
| Natural Aggregate (C) | 259.39 | 207.51 | 207.51 | 181.57 | 181.57 |
| CRCA (C) | / | 51.88 | 51.88 | 77.82 | 77.82 |
| Tap water | 41.69 | / | / | / | / |
| CWater | 1 | 41.69 | 41.69 | 41.69 | 41.69 |
| HRWR | 0.28 | 0.33 | 0.33 | 0.33 | 0.33 |

Note: CBiochar, CRCA, and CWater mean carbonated biochar, RCA, and alkaline water, respectively. In addition, (C) and (F) means coarse and fine-size aggregate, respectively.

### Experimental Testing

### Mechanical Performance

The compressive strength of mortar/concrete specimens was tested using a Multi Station System following the ASTM C1231/C1231M standard test method. A two-stage loading program was employed: the 1^{st} stage featured a loading rate of 2 mm/min before reaching 2500 lbs. aimed to accelerate the testing process while the 2^{nd} stage featured a loading rate of 0.5 mm/min until the specimen failure occurred, aimed to obtain a more reliable result. The peak value of the load was recorded for calculating the strength, and the final compressive strength was calculated by averaging the results from three samples.

### Quantification of Carbonation

Two methodologies were proposed to quantify the carbonation of solid and liquid samples, respectively. For solid samples (i.e., carbonated biochar, carbonated RCA, and CO₂-cured samples), thermal gravimetric analysis was employed to assess the carbonate content and thereby quantify the sequestered CO₂. In this study, the initial and final temperatures of the thermal gravimetric analysis were set at 50° C. and 1000° C., respectively, with a heating rate of 10° C./min. All samples underwent dehydration using anhydrous ethanol before the analysis. For liquid samples (i.e., carbonated supernatant of washout slurry), the sequestered CO₂ could be approximated based on the pH change from 12 to 7. To simplify the estimation, all hydroxide ions (OH⁻) were assumed to be neutralized by CO₂, generating bicarbonate at the same mole concentration. The ionization of bicarbonate ions (HCO₃⁻) was not considered and this simplification slightly underestimated the sequestered CO₂ content.

### Results and Discussion

### Mechanical Performance

### Preliminary CO₂ Footprint Estimation of Mortar Specimens

Based on the methodologies discussed above, the content of sequestered CO₂ for each raw component was estimated and is provided in table 10. Furthermore, the emitted CO₂ content from production of PLC and natural aggregate is presented in table 10 as well for the total CO₂ footprint estimation.

TABLE 10
Sequestered carbon content and equivalent
CO₂ content for each raw component (kg per kg).

| Raw | | | | | | | Natural |
|---|---|---|---|---|---|---|---|
| Component | Biochar | CBiochar | CRCA | RCA | CWater | PLC | Aggregate |
| Carbon | 0.3286 | 0.2195 | 0.0124 | 0.0051 | 0.0002 | 0.21 | 0.0038 |
| Content | | | | | | | |
| Equiv. CO₂ | 1.2049 | 0.8265 | 0.0454 | 0.0186 | 0.0009 | 0.77 | 0.0139 |

| | |
|---|---|
| Captured/Sequestered Carbon | Emitted Carbon |

Note:
CBiochar, CRCA, and CWater mean carbonated biochar, RCA, and alkaline water, respectively.

### Example 18

To explore high rates of substitution, we conducted a study on an engineered cementitious composite (ECC) by replacing 5%, 10%, 20%, 30% by wt. of the OPC, which made up 37% of the mix, with biochar. The remaining constituents in the ECC mix included 22% Class C fly ash, 6% silica fume, 20% sand, 13% water, and about 1% each of a high-range water-reducing admixture, and polypropylene fiber. We measured 3-, 7-, and 28-day compressive strength and drying shrinkage out to 50 days.

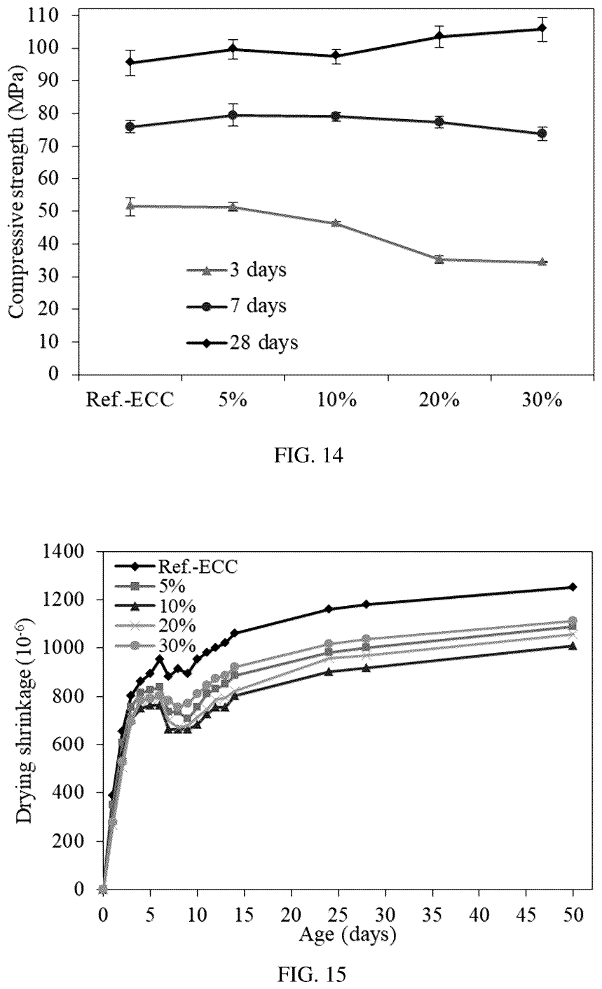

The 3-day compressive strength of the biochar-modified specimens is 10% to 40% lower than that of the control specimens, but the 28-day compressive strength of all biochar-modified specimens is slightly higher than that of control specimens (FIG. 14). This result may be attributed to a delayed pozzolanic reaction in the biochar-modified specimens, which does not occur at the early stage of hydration. Specimens with an OPC replacement of 10% showed the largest reduction of total shrinkage by 20% (FIG. 15). It should be noted that the water-to-binder ratio is 0.195, which means autogenous shrinkage is the dominant portion of total shrinkage. These results confirm the effectiveness of biochar on internal curing.

### Example 19

There are four types of biochar studied in this project, including two derived from biomass: Oregon biochar (wood chips) and Qualterra biochar (wheat straw) and the other two derived from biosolid: OurCarbon biochar (wastewater treatment products) and Heartland biochar (wasted materials).

### Optimization of the Particle Size of Biochar

All the four types of biochar derived from biomass and biosolids are ground by an industrial grade grinder with a designated grinding time (i.e., 20, 30, 40, 50, 60 seconds), respectively. The standard operating procedure (SOP) for obtaining the ground biochar includes four steps. The first step is to weigh 250 grams of raw biochar, place it in the grinder, and close the lid by tightening all the three bolts. The second step is turning the switch of the grinder on and start the countdown of grinding time simultaneously. The third step is to turn off the grinder and collect the ground biochar in a bag with a soft brush after waiting for two minutes for the settle down of tiny particles.

The ground biochar is used as a replacement of cement in cubic cement paste specimens with a size of 2×2×2 inch3. The replacement levels of ground biochar are 5%, 10%, 15%, and 20% by weight of cement. All the cubic specimens have a fixed water-to-cement mass ratio of 0.4 and are cured under 23° C. and the relative humidity of 90±5%. The 7-day and 28-day compressive strength of cured specimens are tested per ASTM C109. The optimal grinding time is determined by the results of 7-day and 28-day compressive strength. In addition, the laser diffraction analysis aims to obtain the particle size distribution of ground biochar.

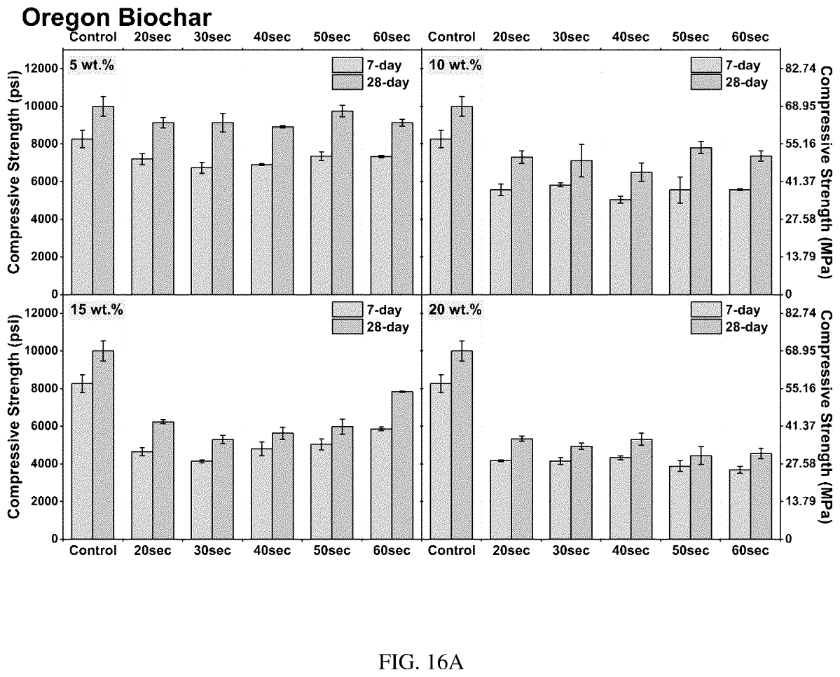

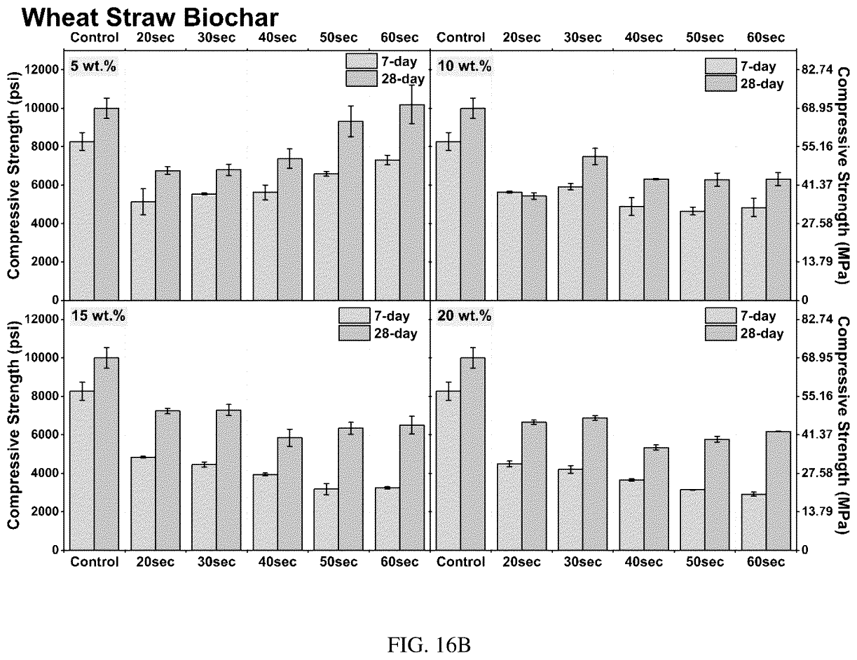

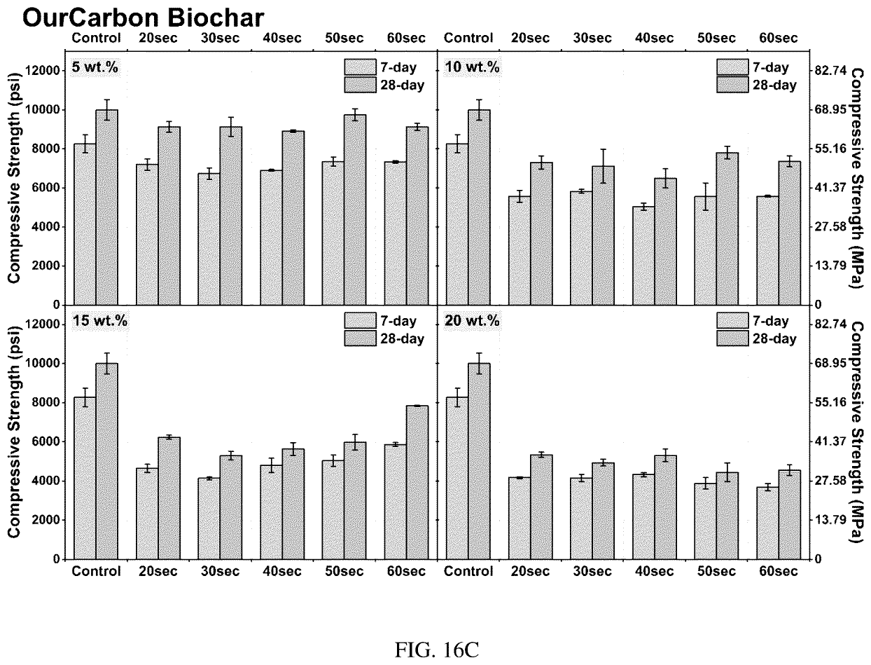

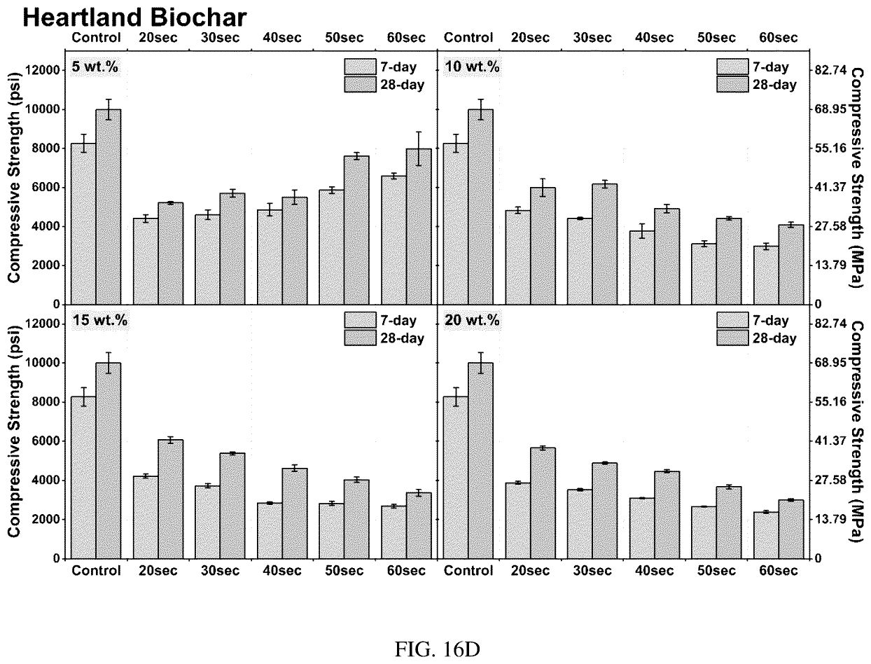

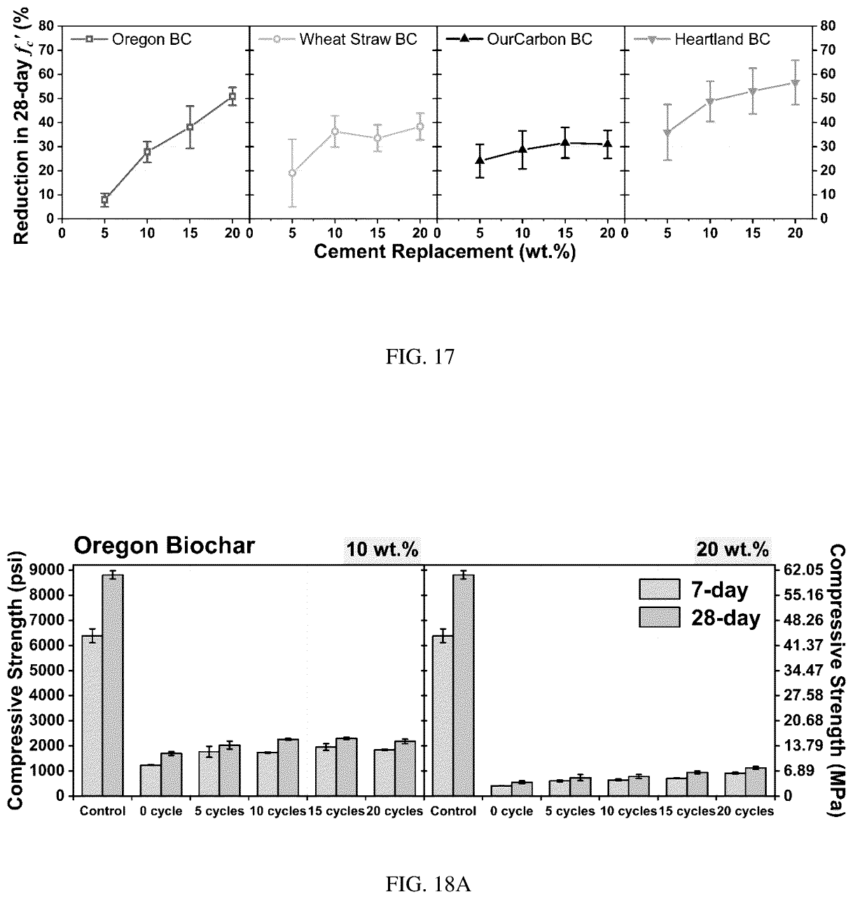

FIG. 16A-D depicts the 7-day and 28-day compressive strength of cement paste specimens with ground biochar. As can be seen, the compressive strength of cement paste specimens decreases with the increase of replacement level of ground biochar. Furthermore, the reduction of compressive strength with a replacement level of 5% wt. is significantly lower than the replacement levels higher than 10% wt. On the other hand, the reducing trend of compressive strength in FIG. 17 seems to have an upper limit with respect to the biochar replacement level and the reduction by biomass-based biochar at the replacement level of 5 wt. % is limited for some specific particle size. According to the results in FIGS. 16 and 17, the optimal replacement level of ground biochar in cement paste is 5% wt. if a high compressive strength of the paste is desired. If only 5,000 psi is needed for the 28-day compressive strength of the paste, then it is possible to replace the cement by biochar up to 20 wt. %.

In terms of retaining high 28-day compressive strength of cement paste, the optimal grinding time for Oregon biochar and OurCarbon biochar is 50 seconds, whereas that for Qualterra biochar and Heartland biochar is 60 seconds. The biomass-based biochar is a more suitable candidate for replacing cement in concrete compared with biosolid-based biochar. The particle size distribution curves of ground Oregon and Qualterra biochar suggest that the optimal grinding duration can produce the finest biochar particles, which is close to the particle size of cement grains and thus helpful to the strength development of cement.

### Modification of Raw Biochar

The operating procedure of CO2 weathering under air is developed for the modification of raw biochar as a replacement of fine aggregate in cement mortar. The CO2 weathering is performed on the raw biochar to produce nano/micro-scale calcite for enhancing the strength and chemical reactivity of biochar. The first step is saturating the biochar with the alkaline concrete washout water. Another revision of the procedure is that a sprayer is used to spray a specific amount of concrete washout water on the biochar instead of simply immersing the biochar in the concrete washout water. The main advantage of this revision is ensuring a consistent quality of concrete washout water and promoting the drying efficiency of CO2 weathering process. The specific amount of concrete washout water for saturating biochars are Oregon (2.640 g/g biochar), Qualterra (2.458 g/g biochar), OurCarbon (0.702 g/g biochar), and Heartland (0.616 g/g biochar), which are determined by the teabag testing method. The CO2 weathering of all the four types of biochar is conducted in the oven with a fan under 70° C. The Carich concrete washout water staying in the pores of biochar can react and precipitate as calcium carbonate.

### Optimization of the Replacement Level of Sand

The numbers of CO2 weathering cycles conducted on the raw biochar are 5, 10, 15, and 20 and the optimal number is determined by the results of 7-day and 28-day compressive strength of cement mortar specimens with CO2 weathered biochar. The replacement levels of CO2 weathered biochar in cement mortar specimens are 10% and 20% by total weight of fine aggregate. All the cubic specimens have a constant water-tocement mass ratio of 0.4 and a constant cement-to-sand ratio of 1:2. They are cured under 23° C. and the relative humidity of 90±5%. Before preparing the cubic mortar specimens, the raw and CO2 weathered biochar is at the saturated surface dry (SSD) condition with tap water and concrete washout water, respectively. Then the raw or CO2 weathered biochar at SSD condition is admixed in the mortar mixture for casting cubic specimens.

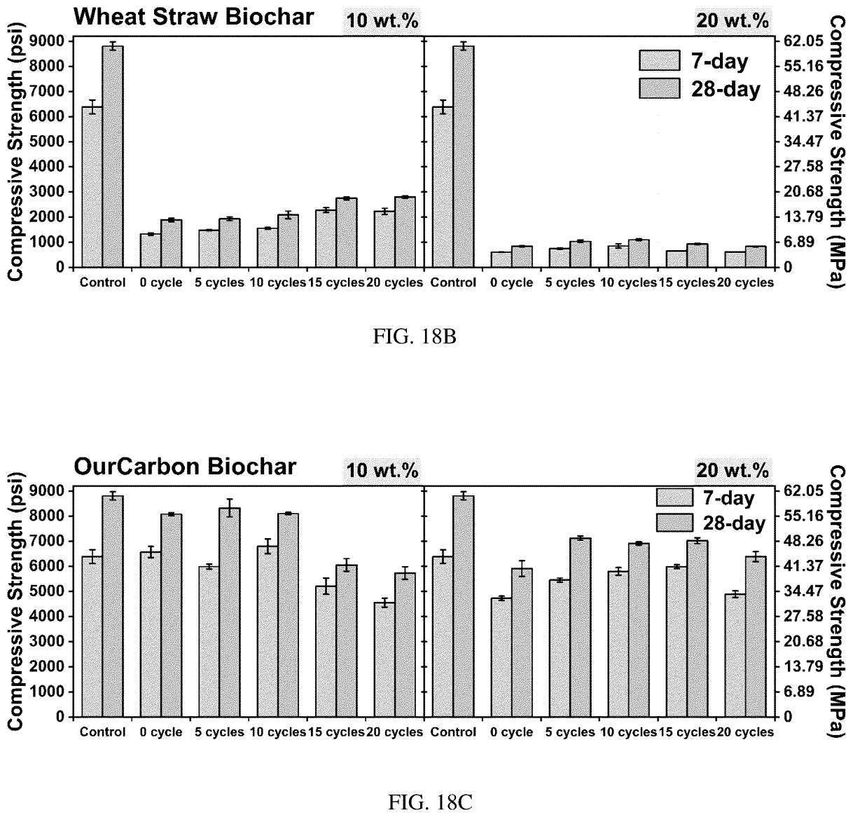

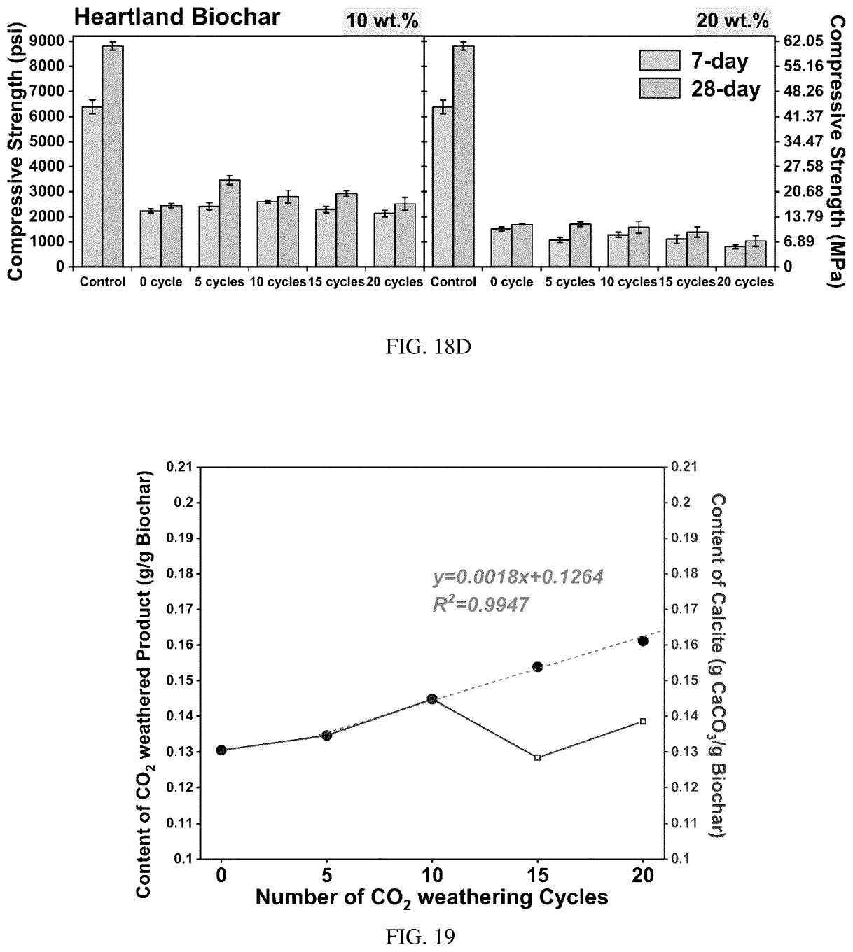

The results of 7-day and 28-day compressive strength of mortar specimens with various replacement of CO2 weathered biochar are shown in FIG. 18A-D. As can be seen, there is a reduction in the 28-day compressive strength of all the mortar specimens with CO2 weathered biochar and the reduction of biosolidbased biochar is much smaller than that of biomass-based biochar, which indicates that OurCarbon biochar is the best candidate to be a replacement of fine aggregate. In terms of minimizing the reduction in compressive strength and maximizing the carbon sequestration, the optimal CO2 weathering cycles of OurCarbon biochar at the replacement of 10% wt. and 20% wt. are 10 and 15, respectively.

The TGA curves illustrate the mass change of raw biochar and CO2 weathered biochar with respect to temperature. The peaks in the DTG curves between 600° C. and 850° C. correspond to the decomposition of calcite. There is a shoulder between the temperature of 500° C. and 600° C. in the raw biochar and it gradually disappears with the increase of CO2 weathering cycles, which can be attributed to the conversion to the carbonated products by CO2 weathering. Therefore, the content of CO2 weathered products in raw biochar and biochar after 5 and 10 cycles are obtained by calculating the mass change between 600° C. and 850° C. while that in biochar after 15 and 20 cycles should be the mass change between 500° C. and 850° C. In FIG. 19, the content of CO2 weathered products in biochar linearly increases with the number of CO2 weathering cycles, however, the content of calcite (i.e., mass change between 600° C. and 850° C.) in biochar first increases and then tends to be constant with respect to CO2 weathering cycles. In addition, a small peak emerges between 400° C. and 500° C. in the biochar after 15 and 20 cycles of CO2 weathering, which is mainly the decomposition of accumulated calcium hydroxide from concrete washout water.

Evaluation of Concrete with Ground and CO2 Weathered Biochar

After determining the suitable biochar as a replacement of cement and sand respectively and the optimal number of CO2 weathering cycles, the evaluation of mechanical strength and durability of concrete specimens with engineered biochar are conducted. The Oregon biochar after 50-second grinding and Qualterra biochar after 60-second grinding are used as a replacement of cement by 5% wt. The OurCarbon biochar after 15 cycles of CO2 weathering are used as a replacement of sand by 20% wt. All the concrete specimens in this sub-task have a constant water-to-cement mass ratio of 0.4, a constant cement-to-fine aggregate ratio of 1:2, and a constant fine aggregate-to-coarse aggregate mass ratio of 1:1.

There are five groups of concrete specimens, including two groups with cement replacement alone (i.e., 5% OR and 5% WS) and another two groups with both cement and sand replacement (i.e., 5% OR+20% OC and 5% WS+20% OC). All the concrete specimens are cured in a sealed bag under 40° C. for 12 days after demolding, which is equivalent to the maturity of concrete specimens cured under room temperature for 28 days. After obtaining the optimal replacement level of modified biochar as fine aggregate, concrete specimens with ground biochar and modified biochar will be prepared for the durability tests. The evaluated properties of the concrete specimens with engineered biochar include compressive strength per ASTM C39 and sorptivity per ASTM C1585.

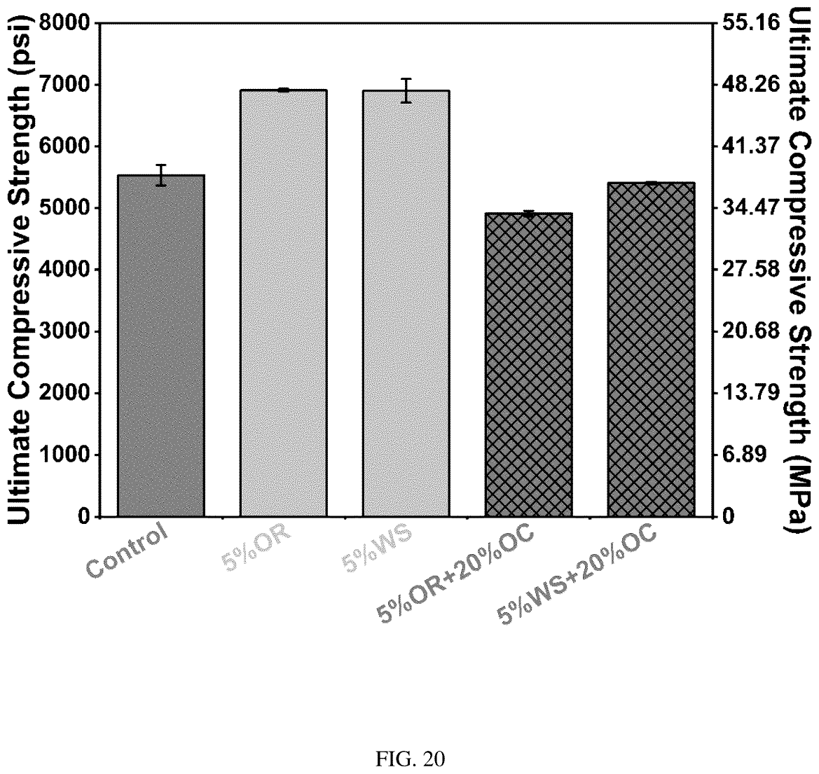

The results of ultimate compressive strength of concrete specimens are demonstrated in FIG. 20. As can be seen, there is an increment of approximately 25% in the ultimate compressive strength of concrete specimens with ground biochar replacing 5 wt. % of cement and the compressive strength of concrete specimens with ground biochar and CO2 weathered biochar is comparable to that of control specimens. Such results indicate that, after the optimal treatment, the biomass-based biochar and biosolid-based biochar can be used for replacing part of the cement and sand in concrete respectively to achieve carbon neutrality.

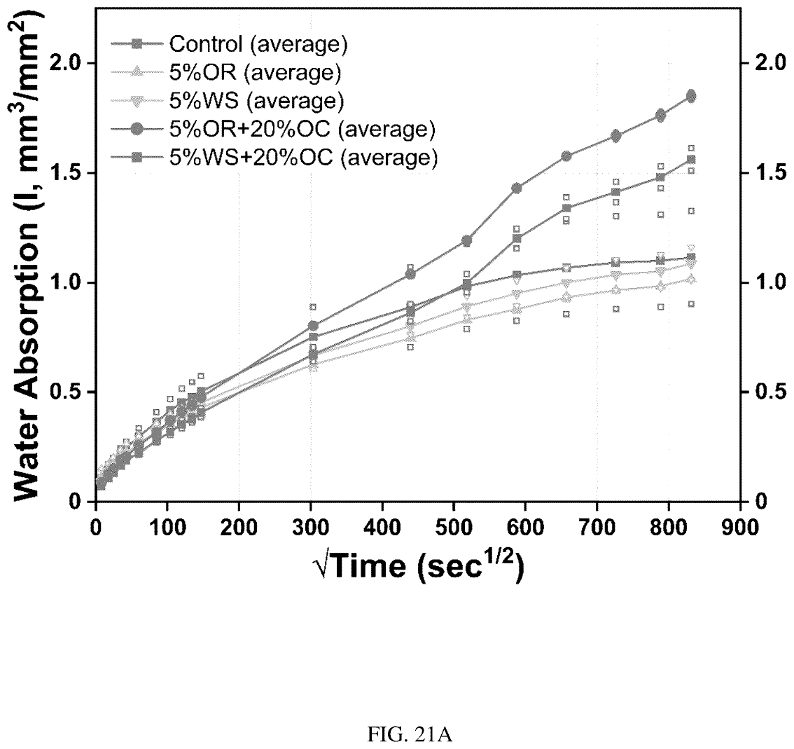

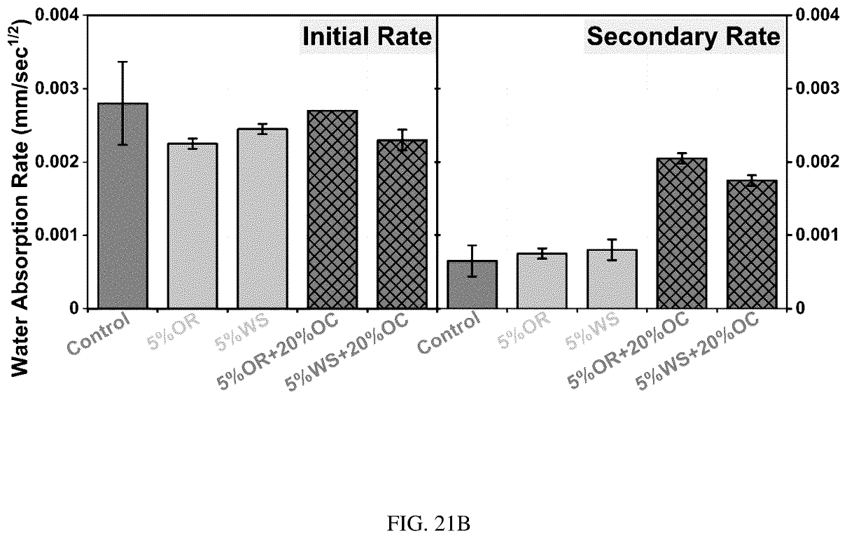

FIG. 21A-B depicts the rate and amount of water absorption of concrete specimens. For concrete specimens with ground biomass-based biochar, the water absorption is about 10% lower compared with that of control specimens, which indicates a denser microstructure. However, for concrete specimens with ground biomass-based biochar and CO2 weathered biosolid-based biochar, the water absorption at the initial stage and secondary stage is comparable to and higher than that of control specimens, respectively. It should be noted that a combination of three types of nonpolymeric water-repelling admixtures are used in these two groups of concrete specimens. This may be attributed to the hypothesis that water-repelling admixtures mainly modify the hydrophobicity of concrete matrix and can hardly modify that of OurCarbon biochar, which leads to an increased water absorption in the long term.

It should be emphasized that the above-described embodiments and specific examples of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A CO₂-weathered biochar, comprising:
a biochar; and
calcium carbonate particles precipitated on or within the biochar, wherein a size of the calcium carbonate particles ranges from 1-5000 nanometers.

2. A cementitious composite, comprising:
a biochar;
calcium carbonate particles precipitated on or within the biochar, wherein a size of the calcium carbonate particles ranges from 1-5000 nanometers;
cement; and
an aqueous solution.

3. The cementitious composite of claim 2, wherein the biochar comprises particles having a size of 150 micrometers or less.

4. The cementitious composite of claim 3, wherein the CO₂-weathered biochar replaces 1% to 80% by mass of a dry pre-mix total quantity of the cement in the cementitious composite.

5. The cementitious composite of claim 4, wherein the CO₂-weathered biochar replaces 1% to 40% by mass of a dry pre-mix total quantity of the cement in the cementitious composite.

6. The cementitious composite of claim 2, wherein the biochar comprises particles having a size of 1-150 micrometers.

7. The cementitious composite of claim 6, wherein the cementitious composite further comprises aggregates and wherein the CO₂-weathered biochar replaces 1% to 20% by mass of a dry pre-mix total quantity of the aggregates in the cementitious composite.

8. The cementitious composite of claim 6, wherein the cementitious composite does not comprise any aggregates.

9. The cementitious composite of claim 6, wherein the cementitious composite comprises recycled aggregate.

10. The cementitious composite of claim 9, wherein the recycled aggregate is carbonated.

11. The cementitious composite of claim 2, wherein a compressive strength of the cementitious composite is increased as compared to a corresponding cementitious composite without the CO₂-weathered biochar.

12. The cementitious composite of claim 2, wherein the cementitious composite is selected from the group consisting of concrete, paste, grout, mortar, and cement stabilized soil.

13. The cementitious composite of claim 2, wherein the biochar is a surface-modified biochar.

14. The cementitious composite of claim 2, wherein the cementitious composite further comprises a fiber material.

15. A method for carbon capture within a cementitious composite, comprising:
mixing a biochar with an alkaline solution to form an intermediate mixture;
exposing the intermediate mixture to a CO₂ source so as to precipitate calcium carbonate particles onto and into the biochar to form a CO₂-weathered biochar, wherein a size of the calcium carbonate particles ranges from 1-5000 nanometers; and
mixing the CO₂-weathered biochar with a cement and an aqueous solution to form the cementitious composite.

16. The method of claim 15, wherein the cementitious composite comprises recycled aggregate and wherein the recycled aggregate is carbonated by
mixing the recycled aggregate with a second alkaline solution to form a second intermediate mixture; and
exposing the second intermediate mixture to a CO₂ source so as to precipitate calcium carbonate onto and into the recycled aggregate to form a CO₂-weathered recycled aggregate.

17. The method of claim 15, wherein the biochar is carbonated.

18. The method of claim 15, wherein the aqueous solution is a carbonated alkaline aqueous solution.

19. The method of claim 15, further comprising pretreating the biochar with a solution containing nanomaterials before the biochar is mixed with the alkaline solution.

20. The method of claim 15, further comprising pretreating the biochar with one or more oxidizing agents before the biochar is mixed with the alkaline solution.
